(19) United States
(12) Patent Application Publication
(10) Pub. No.: US 2026/0051737 A1
(43) Pub. Date: Feb. 19, 2026

(54) POWER CONVERTERS FOR ELECTRONIC DEVICES

(71) Applicant: MILWAUKEE ELECTRIC TOOL CORPORATION, Brookfield, WI (US)

(72) Inventors: Omid H. Shirazi, Wauwatosa, WI (US); Jacob M. Lamb, Jackson, WI (US); David M. Brochtrup, Menomonee Falls, WI (US); Nathan J. Gustafson, Milwaukee, WI (US)

(21) Appl. No.: 19/298,954

(22) Filed: Aug. 13, 2025

Related U.S. Application Data
(60) Provisional application No. 63/683,473, filed on Aug. 15, 2024.
(60) Provisional application No. 63/787,314, filed on Apr. 11, 2025.

(51) Int. Cl. H02J 3/00; H02J 7/00; H02J 9/06; H02M 1/42; H02M 3/335; H02M 7/797

(52) U.S. Cl. CPC H02J 3/007; H02J 7/0063; H02J 9/062; H02J 9/068; H02M 1/4208; H02M 3/33573; H02M 3/33584; H02M 7/797; H02J 2207/20; H02J 2300/24

(57) ABSTRACT

Electronic devices and methods of controlling the same. One method of controlling an electronic device including an AC input interface, an AC output interface, a DC bus, a battery interface, a bidirectional AC/DC active front end (AFE) drive circuit, a bidirectional DC/DC converter, and an electronic processor includes determining a difference between a power level available from the AC input interface and a power demand at the AC output interface, and, in response to the power demand at the AC output interface being greater than or equal to the available power level, (i) controlling an output switch between the AFE drive circuit and the AC output interface to a closed state and (ii) controlling the AFE drive circuit and the bidirectional DC/DC converter to provide supplemental AC output power at the AC output interface using stored energy from a battery electrically connected to the battery interface.

### RELATED APPLICATIONS

This application claims priority to U.S. Provisional Ser. No. 63/683,473, filed Aug. 15, 2025, and U.S. Provisional Ser. No. 63/787,314 , filed Apr. 11, 2025, the entire contents of which are incorporated herein by reference.

### FIELD

Some disclosed embodiments relate to an electronic device that includes a bidirectional power converter.

### SUMMARY

Power conversion (e.g., AC to DC, DC to AC, and/or DC to DC) is used in many devices and applications. For example, portable power supplies, chargers, batteries, and battery cores provide flexibility and convenience for providing power to electronic devices (e.g., power tools, work lights, etc.) at construction sites, but power may need to undergo conversions between such devices in order to be used.

Modular electronic devices can be constructed to be customizable and include any number of interchangeable modules for exchanging power and communications. For example, a user may find that they need multiple charging modules connected to a power supply to adequately charge multiple battery packs. In this situation, the charging modules need to be able to communicate with one another and the power supply to negotiate power transfers. In some instances, modular systems are used by construction personnel to efficiently store and transport construction equipment, for example, power tools, accessories, and the like. Modular systems include wall plates, floor plates, rolling storage boxes, toolboxes, tool kits, organizers, power tools, accessories, and the like that interconnect with each other using modular mounting features. The modular mounting features include physical interfaces to physically interconnect modular devices. These modular mounting features may be modified to also include electrical interfaces to electrically connect modular electronic devices (e.g., power supplies, chargers, batteries, battery cores, and the like).

Power conversion between modular devices may be used in order to allow the modular devices to function properly. Without power conversion, the modular devices may be unable to exchange power and/or may be unable to function as intended. To address the technological problem associated with power conversion in different situations and between various devices, a bidirectional power converter is disclosed that can be interchangeably used in many different situations with many different types of devices (e.g., modular devices) such as different batteries (e.g., battery packs and/or battery cores), different chargers, different portable power supplies, different AC outputs, different AC inputs, etc. For example, embodiments described herein provide an electronic device including an alternating current (AC) input interface, an AC output interface, a direct current (DC) bus, a battery interface, a bidirectional AC/DC active front end (AFE) drive circuit, a bidirectional DC/DC converter electrically connected between the DC bus and the battery interface, an output switch, and an electronic processor. The bidirectional AC/DC active front end (AFE) drive circuit is electrically connected between the AC input interface, the AC output interface, and the DC bus and is configured to convert AC power from the AC input interface to DC power at the DC bus and convert DC power from the DC bus to provide AC power at the AC output interface. The bidirectional DC/DC converter is electrically connected between the DC bus and the battery interface and is configured to convert DC power received from a battery electrically connected to the battery interface to DC power at the DC bus and convert DC power from the DC bus to charge the battery. The output switch is between the AFE drive circuit and the AC output interface. The electronic processor is configured to determine a difference in a power level available at the AC input power and a power demand at the AC output interface, and, in response to the power demand at the AC output interface being greater than or equal to the power level available at the AC input power, close the output switch and control the AFE drive circuit and the bidirectional DC/DC converter to provide AC output power at the AC output interface.

In some examples, the electronic device also includes an input switch between the AC input interface and the AFE drive circuit, wherein the electronic processor is further configured to selectively open or close the input switch based on the power level available at the AC input interface. The electronic processor may be configured to selectively open or close the input switch by maintaining the input switch in a closed state when the power level available at the AC input interface is below the power demand at the AC output interface to enable a supplemental AC output power from both the AC input and the battery interface.

In some examples, the electronic device also includes a plurality of AC input interfaces, each of the plurality of AC input interfaces rated for a different maximum current level, and wherein the electronic processor is configured to select one of the plurality of the AC input interfaces based on an available input current.

In some examples, the AC output interface of the electronic device is one of a plurality of AC output interfaces, each of the plurality of AC output interfaces configured to provide a different maximum output current, wherein the electronic processor is configured to direct output power to one of the plurality of AC output interfaces based on the power level available at the AC input interface and a battery charge state.

In some examples, the electronic device also includes a power factor correction (PFC) circuit electrically connected between the AC input interface and the DC bus, wherein the electronic processor is configured to control the PFC circuit to maintain a desired voltage level at the DC bus when converting power from the AC input interface.

In some examples, the electronic device also includes a power factor correction (PFC) circuit electrically connected between the AC input interface and the DC bus, wherein the electronic processor is configured to control the PFC circuit to maintain a desired voltage level at the DC bus when converting power from the AC input interface.

In some examples, the electronic device also includes a solar boost converter coupled to the battery interface and configured to receive power from a solar interface, the solar boost converter configured to regulate photovoltaic voltage to meet a predefined voltage level for battery charging.

In some examples, in response to the power demand at the AC output interface being less than the power level available at the AC input power, the electronic processor is further configured to open the output switch and control the AFE drive circuit and the bidirectional DC/DC converter to provide DC power output at the battery interface.

In some examples, the electronic processor is further configured to monitor a state of charge of the battery and, in response to the battery reaching a threshold charge level, restrict discharge from the battery.

In some examples, the DC bus is regulated to a voltage between 200 Volts and 400 Volts, and the electronic processor is further configured to maintain the regulation during transitions between operating modes, the operating modes including providing power from the battery interface and providing power to the battery interface.

Embodiments described herein also provide a method of controlling an electronic device including an AC input interface, an AC output interface, a DC bus, a battery interface, a bidirectional AC/DC active front end (AFE) drive circuit, a bidirectional DC/DC converter, and an electronic processor. The method includes determining, via the electronic processor, a difference between a power level available from the AC input interface and a power demand at the AC output interface, and, in response to determining that the power demand at the AC output interface is greater than or equal to the power level available at the AC input interface: controlling, via the electronic processor, an output switch between the AFE drive circuit and the AC output interface to a closed state and controlling, via the electronic processor, the AFE drive circuit and the bidirectional DC/DC converter to provide supplemental AC output power at the AC output interface using stored energy from a battery electrically connected to the battery interface.

In some examples, the method also includes, in response to determining that the power demand at the AC output interface is less than the power level available at the AC input interface: controlling, via the electronic processor, the output switch to an open state, and controlling the AFE drive circuit and the bidirectional DC/DC converter to provide DC power from the AC input interface to the battery interface to charge the battery.

In some examples, the method also includes monitoring, via the electronic processor, a voltage level of the DC bus, and adjusting, via the electronic processor, an operation of the bidirectional DC/DC converter to regulate the voltage of the DC bus within a predefined operating range based on a load condition.

In some examples, the electronic device used with the method further comprises a plurality of AC input interfaces, each having an input switch, and the method further comprises selectively enabling or disabling, via the electronic processor, one or more of the input switches based on input current ratings to provide AC input power.

In some examples, the electronic device used with the method further comprises a solar boost converter electrically coupled to a solar interface and the DC bus, and the method further comprises: controlling, via the electronic processor, the solar boost converter to transfer power from the solar interface to the battery interface or DC bus, and selectively coupling the solar boost converter to one or more DC buses via switch control based on solar input availability.

In some examples, the AC output interface of the electronic device used with the method is one of a plurality of AC output interfaces included in the electronic device, and the method further comprises controlling, via the electronic processor, power from the AC input interface and the battery interface to select ones of the plurality of AC output interfaces based on a current draw or a predefined load threshold.

Some embodiments described herein also provide an electronic device comprising an alternating current (AC) input interface, an AC output interface, a direct current (DC) bus, a battery interface, a power factor correction (PFC) circuit, a bidirectional AC/DC active front end (EFE) drive circuit, a bidirectional DC/DC converter, an output switch, and an electronic processor. The PFC circuit is electrically connected between the AC input interface and the DC bus and is configured to convert AC power from the AC input interface to DC power at the DC bus and to regulate a voltage level of the DC bus. The bidirectional AFE drive circuit is electrically connected between the DC bus and the AC output interface and is configured to convert DC power from the DC bus to provide AC power at the AC output interface, and to convert AC power from the AC output interface to DC power at the DC bus. The bidirectional DC/DC converter is electrically connected between the DC bus and the battery interface and is configured to convert DC power from the battery interface to the DC bus and convert DC power from the DC bus to charge a battery electrically connected to the battery interface. The output switch is between the AFE drive circuit and the AC output interface. The electronic processor is configured to determine a difference between a power level available at the AC input interface and a power demand at the AC output interface, and, in response to determining that the power demand at the AC output interface is greater than or equal to the power level available at the AC input interface, close the output switch and control the AFE drive circuit and the bidirectional DC/DC converter to supplement the AC output power using power from the battery interface. The electronic processor is also configured to, in response to determining that the power demand at the AC output interface is less than the power level available at the AC input interface open the output switch and control the PFC circuit and the bidirectional DC/DC converter to provide DC power from the AC input interface to the battery interface for charging the battery. The electronic processor is further configured to control the PFC circuit to regulate the DC bus voltage to maintain a predetermined power level.

In some examples, the electronic device also includes a solar boost converter electrically connected to the battery interface via a second DC bus, the solar boost converter configured to regulate voltage received from a solar interface and provide charging power to the battery interface.

In some examples, the electronic processor is further configured to control the output switch and the AFE drive circuit to enable a passthrough mode in which AC input power from the AC input interface is directly routed to the AC output interface when the power level at the AC input interface exceeds a predetermined threshold.

In some examples, the AC input interface comprises a plurality of AC input terminals each rated for different current levels, and the electronic processor is configured to selectively enable one or more of the plurality of AC input terminals based on an available grid power.

In some examples, the AC output interface comprises a plurality of output ports, wherein each of the plurality of output ports is controllable by the electronic processor, and the electronic processor is configured to provide power between the plurality of output ports based on a predefined rating or a user-defined parameter.

Some embodiments described herein also provide a method of controlling an electronic device including an AC input interface, an AC output interface, a DC bus, a battery interface, a bidirectional AC/DC active front end (AFE) drive circuit, a bidirectional DC/DC converter, and an electronic processor. The method includes determining, via the electronic processor, a difference between a power level available from the AC input interface and a power demand at the AC output interface, and controlling, via the electronic processor, simultaneous delivery of power from the AC input interface and the battery interface based on the difference between the power level available from the AC input interface and the power demand at the AC output interface.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one. ” Rather these articles should be interpreted as meaning “at least one” or “one or more. ” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 is a simplified block diagram of an electronic/electrical device including a bidirectional power converter in accordance with some example embodiments.

FIG. 2A-2C are perspective views of different electronic devices including the bidirectional power converter of FIG. 1 in accordance with some example embodiments.

FIG. 3 illustrates an example modular ecosystem including example modular electronic devices in accordance with some example embodiments.

FIG. 4 is a schematic illustration of an electronic device representing any of the electronic devices of FIGS. 2A, 2B, and 3 and is a more detailed schematic illustration of the electronic device of FIG. 1 in accordance with some example embodiments.

FIG. 5A is a schematic illustration of the electronic device of FIG. 4 operating in conjunction with DC/DC converter add-on devices to allow battery packs to connect to the electronic device in accordance with some example embodiments.

FIG. 5B is a schematic illustration of the electronic device of FIG. 4 operating in conjunction with the DC/DC converter add-on devices of FIG. 5A according to an alternate embodiment in accordance with some example embodiments.

FIG. 5C is a schematic illustration of an electronic device configured to operate as a bidirectional DC/DC converter without AC power components in accordance with some example embodiments.

FIG. 6A is a schematic illustration of an alternate embodiment of the electronic device of FIG. 4 in accordance with some example embodiments.

FIG. 6B is a schematic illustration of the electronic device of FIG. 6A operating in conjunction with a DC/DC converter add-on device to allow a battery pack 510 to connect to the electronic device in a similar manner as shown in FIG. 5A in accordance with some example embodiments.

FIGS. 7A and 7B illustrate the principles of a load slope being used by the converters disclosed herein in accordance with some example embodiments.

FIGS. 8A, 8B, 8C, 8D, 8E, and 8F illustrates operational modes of controlling power flow for an electronic in accordance with some example embodiments.

FIG. 9A illustrates an example implementation of a dual active bridge (DAB) converter in accordance with some example embodiments.

FIG. 9B illustrates an example implementation of a CLLC converter in accordance with some example embodiments.

FIG. 10 illustrates an example implementation of a buck or boost converter in accordance with some example embodiments.

FIG. 11 illustrates an example implementation of a buck-boost converter in accordance with some example embodiments.

FIG. 12 illustrates a graph of AC output power and DC output power over time to illustrate averaging control that is implemented by a bidirectional DC/DC converter in accordance with some example embodiments.

FIG. 13 is a block diagram of a power system circuit of an electronic device in accordance with some example embodiments.

FIG. 14 is a schematic diagram of an example topology of the power system circuit of FIG. 13 in accordance with some example embodiments.

### DETAILED DESCRIPTION

FIG. 1 illustrates a simplified block diagram of an example electronic (i.e., electrical) device 100. The electronic device 100 includes a battery system 110, an alternating current (AC) source and/or load 120, and a bidirectional power converter 130 electrically connected between the battery system 110 and the AC source and/or load 120. The bidirectional power converter 130 is configured to convert direct current (DC) to AC and is also configured to convert AC to DC as explained in greater detail herein. For example, the bidirectional power converter 130 converts DC power from the battery system 110 to AC power for the load 120 and converts AC power from the AC source/load 120 to DC power to charge the battery system 110. In some instances, the bidirectional power converter 130 may be used in an electronic device 100 (e.g., a power tool 100C as explained herein) such that current is only converted in one direction (e.g., from the battery system 110 to the load 120) even though the bidirectional power converter 130 may be capable of converting current in the opposite direction. As indicated herein, in some instances, the electronic device 100 may be coupled to one or more AC sources (via AC input interfaces) and/or may be coupled to one or more AC loads (via AC output interfaces) of the AC source/load 120. In some instances, the battery system 110 may include one or more batteries (e.g., one or more battery packs and/or one or more battery cores) that are coupled to the bidirectional power converter 130 via a battery interface (e.g., battery ports and/or other electrical connections). It should be understood that any of the input or output interfaces described herein may be interchangeably referred to as AC or DC input or output interfaces, depending upon their described configuration. For example, an output interface that provides AC output power may also be referred to as an AC output interface.

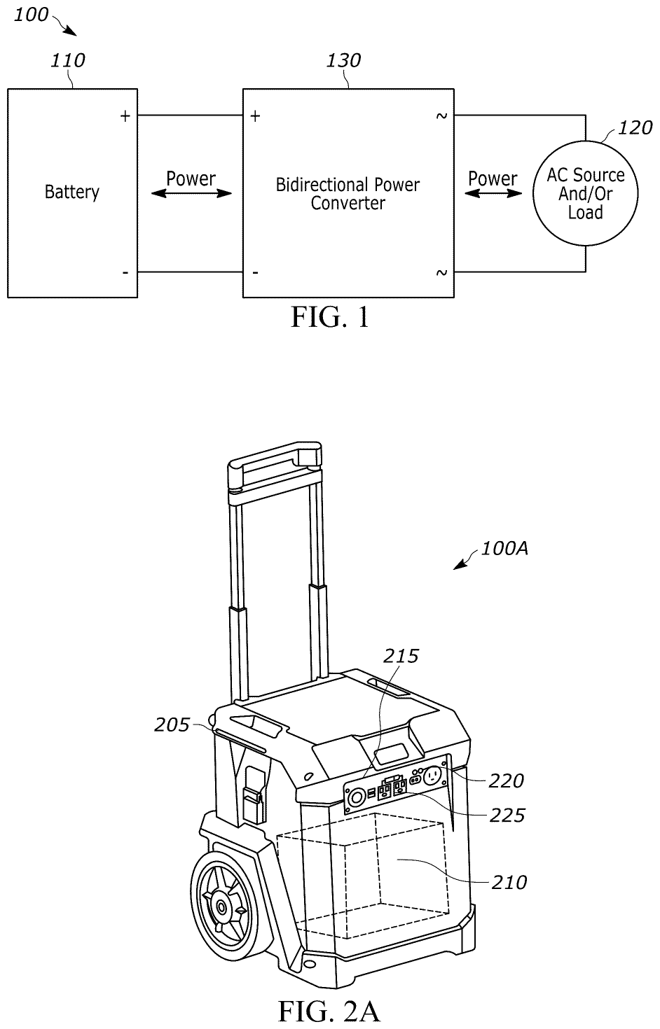

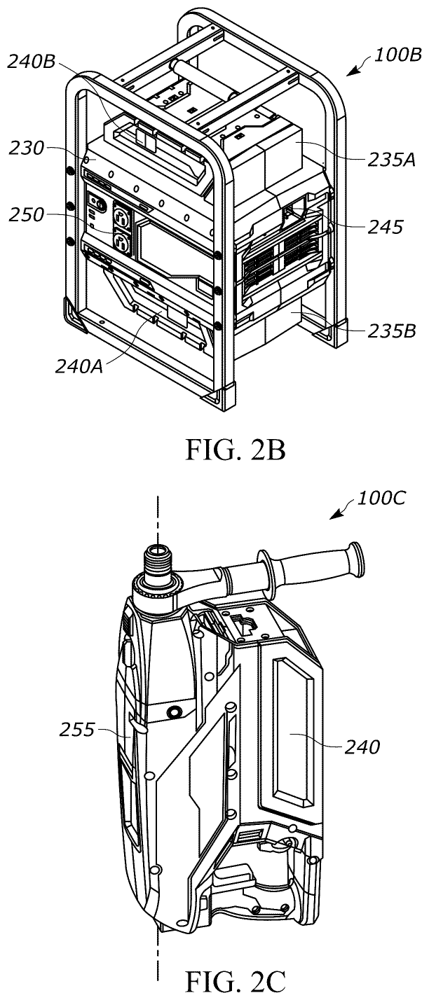

FIG. 2A illustrates an example electronic device 100 in the form of a portable power source 100A, also referred to as a portable power supply. The portable power source 100A includes a housing 205 for housing an internal battery system 210. The housing 205 also includes an input/output panel 215. The input/output panel 215 includes an input interface 220 (e.g., AC power input interface) for receiving an AC power and an output interface 225 (e.g., AC power output interface). The output interface 225 is for example, an AC power outlet for powering AC electronic devices. The internal battery system 210 corresponds to the battery system 110. In some instances, the internal battery system includes an integrated battery core that is not configured to be removable from the housing 205 by a user. A battery interface may provide an electrical connection between the battery system 110 and the bidirectional power converter 130. The input interface 220 and the output interface 225 correspond to the source and load of the AC source/load 120, respectively. The bidirectional power converter 130 is coupled between the internal battery system 210, the input interface 220, and the output interface 225. The bidirectional power converter 130 converts DC power from the internal battery system 210 to AC power for the output interface 225. The bidirectional power converter 130 also converts the AC power from the input interface 220 to DC power for charging the internal battery system 210. The portable power source 100A may include additional components other than those described and illustrated herein. For example, the portable power source 100A may include additional output interfaces 225 (e.g., both AC power output and DC power outputs), additional battery interfaces/ports to receive battery packs, a display, a wireless transceiver to communicate with an external device such as a smart phone, and/or the like.

FIG. 2B illustrates an example electronic device 100 in the form of another portable power source 100B, also referred to as a portable power supply. The portable power source 100B includes a housing 230 having a first battery interface 235A and a second battery interface 235B. The first battery interface 235A and the second battery interface 235B are configured to respectively receive a first removable power tool battery pack 240A and a second removable power tool battery pack 240B. The first removable power tool battery pack 240A and the second removable power tool battery pack 240B, referred singularly as a removable power tool battery pack 240, are for example, lithium-ion power tool battery packs having a nominal voltage of 12 Volts, 18 Volts, 24 Volts, 36 Volts, 54 Volts, 72 Volts, 90 Volts, 108 Volts, or the like. The removable power tool battery pack 240 may be used to power cordless indoor and outdoor power tools. The portable power source 100B also includes a input interface 245 (e.g., AC power input interface) and a output interface 250 (e.g., AC power output interface). The output interface 250 is for example, an AC power outlet for power AC electronic devices. The removable power tool battery packs 240 correspond to the battery system 110. The input interface 245 and the output interface 250 correspond to the source and load of the AC source/load 120, respectively. The bidirectional power converter 130 is coupled between the removable power tool battery packs 240, the input interface 245, and the output interface 250. The bidirectional power converter 130 converts DC power from the removable power tool battery packs 240 to AC power for the output interface 250. The bidirectional power converter 130 also converts the AC power from the input interface 245 to DC power for charging the removable power tool battery packs 240. The portable power source 100B may include additional components other than those described and illustrated herein. For example, the portable power source 100B may include one or more additional output interfaces 250 (e.g., both AC power outputs and DC power outputs), additional battery interfaces (e.g., for different types of removable batteries), a display, a wireless transceiver to communicate with an external device such as a smart phone, and/or the like.

FIG. 2C illustrates an example electronic device 100 in the form of a power tool 100C. In the example illustrated, the power tool 100C is a handheld core drill. The power tool 100C may include a different type of indoor and outdoor, handheld or mounted, power tool, for example, drill/drivers, saws, hammer drills, lighting equipment, grinders, or the like. The power tool 100C includes a housing 255 that houses a motor and that receives a removable power tool battery pack 240. The removable power tool battery pack 240 corresponds to the battery system 110 and the motor corresponds to the load 120. The bidirectional power converter 130 is coupled between the removable power tool battery pack 240 and the motor. The bidirectional power converter 130 converts DC power from the removable power tool battery pack 240 to AC power for the motor. In some examples, the power tool 100C may further include a power cord to receive AC power. In these examples, the bidirectional power converter 130 also converts the AC power from the power input or from the motor to DC power for charging the removable power tool battery pack 240. The power tool 100C may include additional components other than those described and illustrated herein.

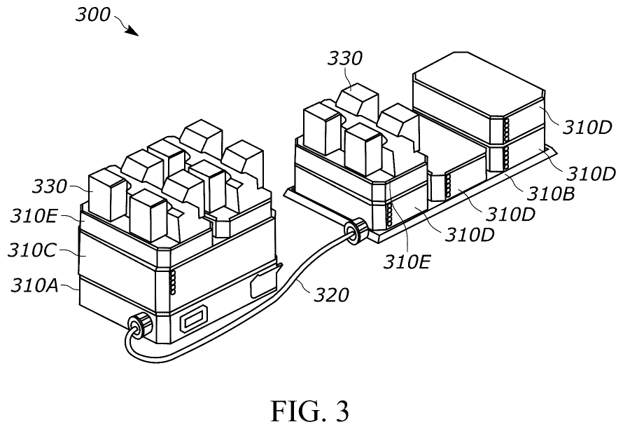

FIG. 3 illustrates an example modular ecosystem 300. The modular ecosystem 300 includes a plurality of modular electronic devices 310 electrically and physically coupled together, for example, using modular mounting features and/or wires 320. The modular ecosystem 300 allows for both power transfer and communication between the various modular electronic devices 310. The communication may be performed using a controller area network (CAN) bus protocol. The modular electronic devices 310 include, for example, a portable power supply 310A, a floor plate 310B, a full width module 310C (e.g., a power core of battery cells), a plurality of half width modules 310D (e.g., a small core of battery cells), and a plurality of charging modules 310E for charging battery packs 330. In one example, the wire 320 may include a cord that allows for power transfer and CAN bus communication between the connected modular electronic devices 310. The wire 320 provides an alternate connection scheme (e.g., daisy-chain) to connect the modular electronic devices 310.

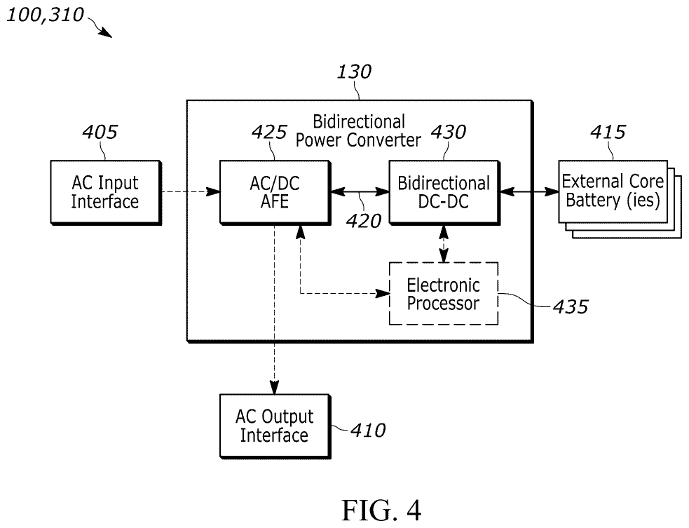

In some instances, the portable power sources 100A and 100B are part of a modular ecosystem 300 and may be referred to as modular electronic devices. For example, the housing 205, 230 of the portable power source 100A, 100B includes modular mounting features (not shown) provided on a top surface of the housing 205, 230. Corresponding interlocking modular mounting features may be provided on bottom surface of the housing 205, 230 that interlock with the modular mounting features on the top of another modular electronic device 310 that includes interlocking modular mounting features. The portable power source 100A, 100B represents an active modular electronic device 310 including an electronic processor 435 (see FIG. 4). In some instances, the modular ecosystem 300 includes one or more passive modular electronic devices 310 that may not include an electronic processor but that may nonetheless provide CAN bus communication capabilities and/or power transfer capabilities for modular electronic devices 310 coupled to the passive modular electronic devices 310.

FIG. 4 is a schematic illustration of an electronic device 100, 310, for example, any of the plurality of electronic devices 310, or portable power sources100A, 100B. FIG. 4 is a more detailed schematic illustration of the electronic device 100 of FIG. 1. Accordingly, instead of the AC source and/or load 120 as shown in FIG. 1, FIG. 4 separately shows an input interface 405 and an output interface 410 for AC power(e.g., corresponding to the like-named components shown in FIGS. 2A-2B). The input interface 405 may receive, for example, 85-265 VAC from an AC power source coupled to the input interface 405. The output interface 410 may output, for example, 120-240 VAC via one or more outlets on the housing 205, 230 of the electronic device 100, 310. The electronic device 100, 310 also includes a battery interface that is coupled to one or more batteries 415 (e.g., external core batteries 415, for example having a nominal voltage of approximately 100 Volts) that correspond to battery system 110 of FIG. 1. The electronic device 100, 310 also includes the bidirectional power converter 130 (i.e., bidirectional AC/DC converter). In some instances, the bidirectional power converter 130 includes a DC bus 420 that is electrically coupled between a bidirectional AC/DC active front end (AFE) drive circuit 425 and a bidirectional DC/DC converter 430. In some instances, the DC bus 420 is maintained/regulated at approximately 400 Volts. Although the batteries 415 are labeled as external core batteries 415 in FIG. 4, in some instances, the batteries 415 include an internal core battery that is housed within the housing 205, 230 of the electronic device 100, 310 and configured not to be removed from the housing 205, 230. The reference to “external” core battery(ies) merely indicates that the bidirectional DC/DC converter 430 is not integrated into the battery(ies) 415 itself (e.g., within the housing of the battery(ies) 415). However, some embodiments disclosed herein include batteries with the bidirectional DC/DC converter 430 integrated within the battery/battery housing.

As shown in FIG. 4, the bidirectional AC/DC AFE drive circuit 425 is electrically connected between the input interface 405, the output interface 410, and the DC bus 420. In some instances, the bidirectional AC/DC AFE drive circuit 425 is configured to convert AC power from the input interface 405 to DC power at the DC bus 420. In some instances, the bidirectional AC/DC AFE drive circuit 425 is also configured to convert DC power from the DC bus 420 to provide an AC output from the output interface 410. Also as shown in FIG. 4, the bidirectional DC/DC converter 430 is electrically connected between the DC bus 420 and the battery interface that electrically couples to the battery(ies) 415. In some instances, the bidirectional DC/DC converter 430 is configured to convert DC power received from a battery 415 electrically connected to the battery interface to DC power at the DC bus 420. In some instances, the bidirectional DC/DC converter 430 is also configured to convert DC power from the DC bus 420 to charge the battery 415.

In the example electronic device 100, 310 shown in FIG. 4, the bidirectional power converter 130 may operate as both a charger and an inverter in a single electronic device 100, 310, for example, to reduce size and weight compared to having separate devices with separate functions. For example, the batteries 415 may be charged from the DC bus 420 using power that is at least partially provided by an AC power source (e.g., a conventional wall outlet, such as a 120 V outlet or a 240 V outlet, found in North America) coupled to the input interface 405.

Additionally, the output interface 410 may receive power from the DC bus 420 that is ultimately provided by the AC power source via the input interface 405 and/or by the batteries 415 via the bidirectional DC-DC converter 430. In some instances, when multiple external core batteries 415 are used in/with the electronic device 100, 310, all such batteries 415 may operate over the same voltage range. In some instances, multiple batteries 415/battery cores 415 may be simultaneously charged and/or discharged via their connections with the DC bus 420 via respective bidirectional DC-DC converters 430 for each battery 415/battery core 415.

In some instances, the electronic device 100, 310 also includes an optional electronic processor 435 electrically connected to the bidirectional AC/DC AFE drive circuit 425 and the bidirectional DC/DC converter 430. The electronic processor 435 may also be electrically and/or communicatively connected to a variety of other components of the electronic device 310. For example, the electronic processor 435 may be connected to and/or receive information from sensors that are connected to the input interface 405, the output interface 410, the batteries 415 (e.g., via the battery interface), a transceiver for communicating with an external device and/or with other modular electronic devices 100, 310, and/or other components.

The electronic processor 435 may include combinations of hardware and software that are operable to, among other things, control the operation of the electronic device 100, 310 in some instances. For example, the electronic processor 435 may be embodied as a microprocessor, a microcontroller, or another suitable programmable device. The electronic processor 435 may include and/or be coupled to a memory, input units, and output units. The electronic processor 435 may include, among other things, a control unit, an arithmetic logic unit (“ALU”), and a plurality of registers and may be implemented using a known computer architecture (e.g., a modified Harvard architecture, a von Neumann architecture, etc.). Although the electronic processor 435 is illustrated in FIG. 4 as one electronic processor, the electronic processor 435 could also include multiple electronic processors configured to work together to achieve a desired level of control for the electronic device 100, 310. As such, any control functions and processes described herein with respect to the electronic processor 435 could also be performed by two or more electronic processor functioning in a distributed manner (e.g., separate but communicatively connected electronic processors being included in each of the bidirectional AC/DC AFE drive circuit 425 and the bidirectional DC/DC converter 430).

The memory associated with the electronic processor 435 is a non-transitory computer readable medium and includes, for example, a program storage area and a data storage area. The program storage area and the data storage area can include combinations of different types of memory, such as a read only memory (“ROM”), a random access memory (“RAM”) (e.g., dynamic RAM [“DRAM”], synchronous DRAM [“SDRAM”], etc.), electrically-erasable programmable ROM (“EEPROM”), flash memory, a hard disk, an SD card, or other suitable magnetic, optical, physical, or electronic memory devices. The electronic processor 435 includes and/or is connected to the memory and is configured to execute software instructions that are capable of being stored in a RAM of the memory (e.g., during execution), a ROM of the memory (e.g., on a generally permanent basis), or another non-transitory computer readable medium such as another memory or a disc. Software included in the implementation of the electronic device 100, 310 and electronic processor 435 can be stored in the memory of the electronic processor 435. The software includes, for example, firmware, one or more applications, program data, filters, rules, one or more program modules, and other executable instructions. The electronic processor 435 is configured to retrieve from the memory and execute, among other things, instructions related to the control processes and methods described herein. In other embodiments, the electronic processor 435 includes additional, fewer, or different components.

In some instances, the electronic processor 435 facilitates the transfer of power and communication between the modular electronic devices 310 of the modular ecosystem 300 and/or between other disclosed components (e.g., batteries 415, the input interface 405, and/or the output interface 410). In instances of the electronic device 100, 310 that include a transceiver, the transceiver may send and receive data from the electronic device 100, 310 to other electronic devices. For example, the transceiver may allow the electronic processor 435 to communicate with other electronic devices over a network or via a wired connection (e.g., over the CAN bus). The transceiver may be a traditional CAN transceiver, a CAN transceiver with an adjustable rise and fall time, or a CAN Signal Improvement Capability (SIC) transceiver. The transceiver may additionally or alternatively include a wireless transceiver to communicate with an external device such as a smart phone to, for example, receive commands from the smart phone regarding operation of the electronic device 100, 310 (e.g., which power source to utilize, which battery to charge, whether to charge or discharge batteries sequentially or simultaneously, etc.).

In some instances, the electronic device 100, 310 is configured to be interchangeably used with a plurality of combinations of AC output devices that are coupleable to the output interface 410 and external batteries 415 that are coupleable to the battery interface. In such instances, each of the AC output devices is configured to receive an AC output from the output interface 410. In some instances, different AC output devices are configured to receive different AC outputs from the output interface 410 (i.e., different outlets of the output interface 410). In some instances, the different batteries 415 coupleable to the battery interface of the electronic device 100, 310 have different nominal voltages, different charging parameters, or both different nominal voltages and different charging parameters. In some instances, the electronic processor 435 may be specifically programmed to operate differently depending on the characteristics of power sources and loads that are planned to be connected to the electronic device 100, 310. In some instances, the electronic processor 435 may be configured to determine the different characteristics of attached power sources and power loads to convert power from power sources to be provided to the DC bus 420 and to convert power from the DC bus to be provided to different power loads in accordance with their respective characteristics.

In some instances, the electronic processor 435 is configured to determine a characteristic of the AC power (e.g., a voltage level and/or the like) from the input interface 405. The electronic processor 435 may be further configured to determine a characteristic of the DC power (e.g., nominal voltage, charge level, a charging parameter, and/or the like) from the battery(ies) 415. The electronic processor 435 may be further configured to control the bidirectional AC/DC AFE drive circuit 425 to maintain the DC bus 420 at a bus voltage based on the characteristic of the AC power from the input interface 405. The electronic processor 435 may be further configured to control the bidirectional DC/DC converter 430 to maintain the DC bus 420 at the bus voltage based on the characteristic of the DC power from the battery(ies) 415. The electronic processor 435 may be further configured to control at least one of the bidirectional AC/DC AFE drive circuit 425 and the bidirectional DC/DC converter 430 to allow the electronic device 100, 310 to provide the AC output from the output interface 410, charge the battery(ies) 415, or both provide the AC output from the output interface 410 and charge the battery(ies) 415. In some instances, the electronic processor 435 is configured to communicate with the battery(ies) 415 to determine at least one of the group consisting of the characteristic of the DC power from the battery(ies) 415, a nominal voltage of the battery(ies), a charging parameter of the battery(ies) 415, and combinations thereof. For example, the electronic processor 435 may be configured to communicate with the battery(ies) 415 using a controller area network (CAN) bus. In other instances, the electronic processor 435 may determine a characteristic of the DC power from the battery(ies) 415 merely by using one or more sensors. In some configuration, the electronic processor 435 is configured to monitor a voltage level of the DC bus (e.g., via data received from one or more sensors) and adjust an operation of the bidirectional DC/DC converter 430 to regulate the voltage of the DC bus within a predefined operation range based on a load condition.

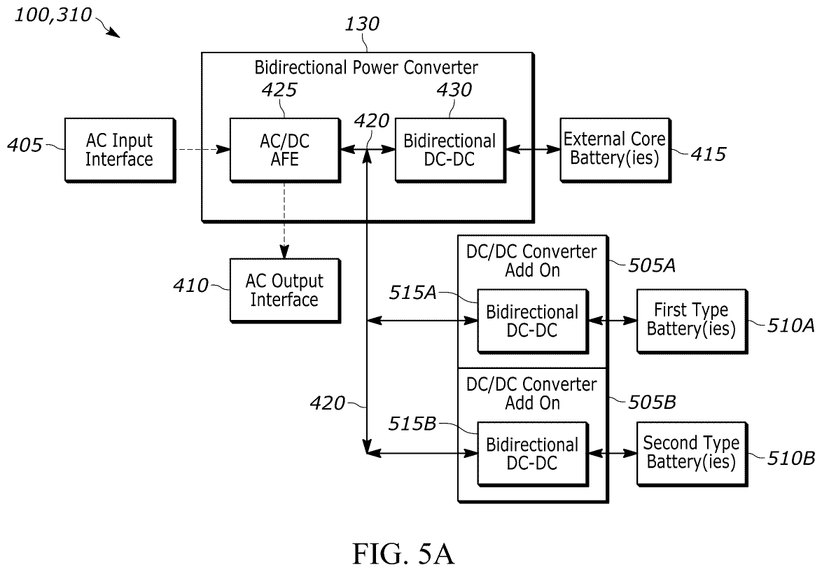

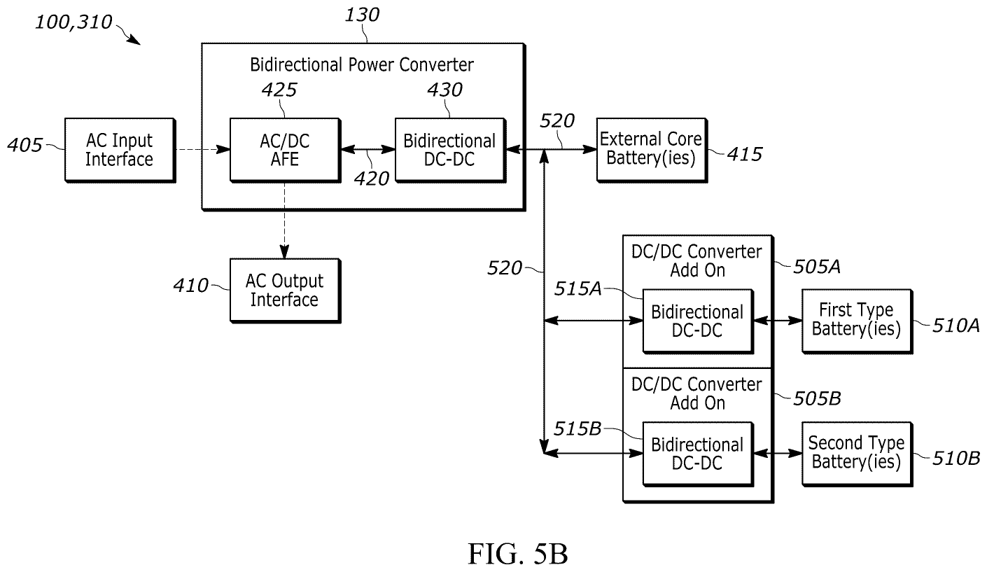

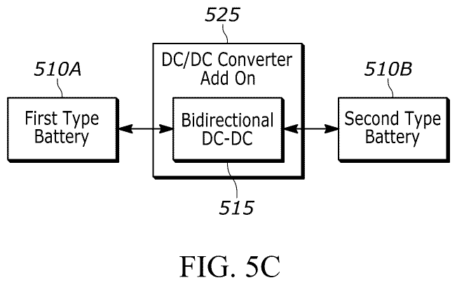

FIG. 5A is a schematic illustration of the electronic device 100, 310 of FIG. 4 operating in conjunction with DC/DC converter add-on devices 505 to allow battery packs 510 to connect to the electronic device 100, 310. Using the electronic device 100, 310 in conjunction with the add-on devices 505 allows for increased functionality and versatility of the system of devices 100, 310, 505. For example, the DC bus 420 may additionally receive power from the battery packs 510 such that the battery packs 510 at least partially provide power to the output interface 410 and/or to the core battery(ies) 415 for charging of the core battery(ies) 415. As another example, any of the batteries 415, 510A, 510B may be charged using power from the DC bus 420 that may be provided at least partially by other batteries 415, 510A, 510B. In other words, power can be selectively moved from one type of battery to another type of battery (i.e., DC/DC charging) via the DC bus 420 and respective bidirectional DC/DC converters 430, 515A, 515B. In some instances, some batteries 415, 510A, 510B can be charged while other batteries 415, 510A, 510B are simultaneously discharged. In some instances, multiple batteries 415, 510 may be simultaneously or sequentially charged and/or discharged via their connections with the DC bus 420 via respective bidirectional DC-DC converters 430 for each battery 415, 510. A user input via a user input device on the electronic device 100, 310 may select which components receive power from the DC bus 420 and which components provide power to the DC bus 420 at any given time.

As shown in FIG. 5A, two DC/DC converter add-on devices 505A and 505B are coupled to the electronic device 100, 310. In some instances, the add-on devices 505A and 505B are modular electronic devices 310 configured to removably electrically and communicatively couple to the electronic device 100, 310 and configured to removably receive one or more battery packs 510. For example, the add-on devices 505 may be embodied as a floor plate 310B, a charging module 310E, and/or the like. Each add-on device 505 may be configured to removably receive one or more of a certain type of battery pack 510. For example, the add-on device 505A may be configured to removably receive a first type of battery pack 510A such as an 18 Volt (nominal voltage) battery pack. The battery pack 510A may be configured to removably couple to a handheld power tool that is configured to be used with a single hand during operation (e.g., a power drill, an impact wrench, etc.). As another example, the add-on device 505B may be configured to removably receive a second type of battery pack 510B such as a 72 Volt (nominal voltage) battery pack. The battery pack 510B may be configured to removably couple to a larger power tool that is configured for two-hand use by an operator and/or that includes wheels or other transportation methods to aid the user to move the power tool (e.g., a push lawn mower). The battery pack 510B may be larger in Voltage, output capacity, size, and/or weight compared to the battery pack 510A. The battery packs 510A and 510B also may be configured to mechanically connect to their respective add-on devices 505A and 505B and power tools in different manners (e.g., different rail structures, latching mechanisms, etc.). The battery packs 510 described above are merely examples. Other different types of battery packs are also contemplated.

In addition to having a battery interface to mechanically and electrically connect to a battery pack 510, each add-on device 505 may include an interface to removably couple the add-on device 505 to the electronic device 100, 310 (e.g., mechanically and electrically). For example, this interface may of the add-on device 505 may mate include a physical/mechanical mechanism (e.g., rails, grooves, latching mechanism(s), etc.) to mate with a corresponding physical/mechanical mechanism of the electronic device 100, 310. In some instances, the interface between the add-on device 505 and the electronic device 100, 310 includes power terminals to transfer power between the add-on device 505 and the electronic device 100, 310 and/or communication terminals to allow for communication between the add-on device 505 and the electronic device 100, 310. In some instances, the interface between the add-on device 505 and the electronic device 100, 310 connects directly to the DC bus 420 of the electronic device 100, 310.

Each add-on device 505 includes a bidirectional DC/DC converter 515 for each battery pack 510. Each bidirectional DC/DC converter 515 may be configured to operate with the type of battery pack 510 that the add-on device 505 is configured to receive. For example, each bidirectional DC/DC converter 515 is configured to accommodate a certain battery pack voltage, battery pack chemistry, battery pack cell arrangement, and the like. The bidirectional DC/DC converters 515 may also be configured to convert DC power from their respective type of battery pack 510 to DC power (e.g., 400 Volts) at the DC bus 420 of the electronic device 100, 310. Accordingly, the electronic device 100, 310 and the add-on devices 505 form a combined device that allows power to be received and provided between various sources, loads, and batteries (e.g., different types of batteries that have different characteristics) on the DC bus 420 as part of a unified device/system as explained herein.

Accordingly, as shown in FIG. 5A, the electronic device 100, 310 is configured to couple to a first battery 415 (e.g., a core battery of the electronic device 100, 310), to a second battery 510A (e.g., a battery pack of a first type), and to a third battery 510B (e.g., a battery pack of a second type different than the first type). The electronic device 100, 310 may couple to additional or fewer batteries than the example shown in FIG. 5A.

The electronic processor 435 is not shown in FIG. 5A but the electronic processor 435 may nevertheless be present in the electronic device 100, 310 shown in FIG. 5A as explained previously herein with respect to FIG. 4. In some instances, the DC/DC converter add-on devices 505 may also each include an electronic processor that is similar to the electronic processor 435 described previously herein.

In some instances, the bidirectional DC/DC converter 430 of the electronic device 100, 310 is configured to receive DC power from the second battery 510 (e.g., one or both of the batteries 510A and 510B) at the DC bus 420. For example, the respective bidirectional DC/DC converter 515A, 515B of the add-on devices 505A, 505B may convert DC power from the respective battery pack 510A, 510B to DC power provided to the DC bus 420 (e.g., 400 Volts). The bidirectional DC/DC converter 430 of the electronic device 100, 310 may also be configured to convert DC power from the DC bus 420 to charge the second battery (e.g., one or both of the batteries 510A and 510B) via their respective bidirectional DC/DC converters 515A, 515B.

As explained previously herein, in some instances, the electronic processor 435 is configured to selectively control the bidirectional DC/DC converter 430 of the electronic device 100, 310 to allow a first battery (e.g., battery 415) to at least partially charge the second battery (e.g., battery pack 510A and/or 510B) and to allow the second battery (e.g., battery pack 510A and/or 510B) to at least partially charge the first battery (e.g., battery 415). For example, a user input received via a display on the electronic device 100, 310 or received via a command from an external device (e.g., smart phone) may indicate which of the connected batteries 415, 510A, 510B, etc.) that the user desires to be charged from the DC bus 420.

FIG. 5B is a schematic illustration of the electronic device 100, 310 of FIG. 4 operating in conjunction with the DC/DC converter add-on devices 505 of FIG. 5A according to an alternate embodiment. The above explanation of the devices and components shown in FIG. 5A applies to FIG. 5B except with respect to the differences shown in FIG. 5B as explained below. In FIG. 5B, the add-on devices 505 still allow additional battery packs 510 to connect to the electronic device 100, 310 to provide increased functionality and versatility. However, as shown in FIG. 5B, the add-on devices 505 interface with a core battery bus 520 of the electronic device 100, 310 instead of interfacing with the DC bus 420 of the electronic device 100, 310. In other words, the additional/second battery(ies) (e.g., battery packs 510) couples to the electronic device at a battery bus that is downstream of the bidirectional DC/DC converter 430 such that the DC power from the battery interface is provided by a combination of the battery 415 and the second battery(ies) 510. As explained previously herein with respect to FIG. 5A, each add-on device 505 may include a battery interface to removably couple to a battery 510 (e.g., mechanically and electrically) and may include an additional interface to removably couple the add-on device 505 to the electronic device 100, 310 (e.g., mechanically and electrically). In some instances, the additional interface between the add-on device 505 and the electronic device 100, 310 connects directly to the core battery bus 520 of the electronic device 100, 310.

Depending on certain applications and desired functionality of the system, one of the embodiments shown in FIGS. 5A and 5B may be selected. For example, in the embodiment of FIG. 5A, a power stage design is small and efficient (e.g., a narrow voltage conversion ratio) since the add-on devices 505 always interface with the DC bus 420 of the electronic device 100, 310. However, DC/DC charging may experience inefficiencies since there are multiple power conversions that occur between batteries 415, 510A, 510B. On the other hand, in the embodiment of FIG. 5B, the add-on devices 505 interface with the core battery bus 520 that may vary in battery cell voltages (e.g., 2.5 Volts per cell to 4.2 Volts per cell). Accordingly, in the embodiment shown in FIG. 5B, the add-on devices 505 are configured to support a wide voltage conversion ratio (e.g., a wider voltage conversion ratio than they may support in the embodiment shown in FIG. 5A). However, as a tradeoff for this wider voltage conversion ratio, DC/DC charging between batteries 415, 510A, 510B only goes through one stage of power conversion, which makes DC/DC charging/power transfer more efficient.

FIG. 5C is a schematic illustration of an electronic device 525 (i.e., a DC/DC converter add-on device 505 embodied as the electronic device 525) configured to operate as a bidirectional DC/DC converter without AC power components. For example, the electronic device 525 may be similar to the electronic devices 100, 310 described previously herein and shown in FIG. 5A or 5B but does not include the input interface 405, the output interface 410, or the bidirectional AC/DC AFE drive circuit 425. Rather, the electronic device 525 may be configured to transfer DC power from one or more batteries 415, 510 to one or more other batteries 415, 510. In some instances, the electronic device 525 has similar components and functionality as the DC/DC converter add-on devices 505 described herein. The above explanation of like-named and liked-numbered devices and components shown in FIGS. 5A and 5B applies to FIG. 5C.

In some instances, the electronic device 525 is a modular electronic device 310 configured to electrically couple to two or more batteries 415, 510. In some instances, the electronic device 525 is a stand-alone adapter configured to electrically couple between two or more batteries 415, 510. In the example shown in FIG. 5C, the electronic device 525 includes a bidirectional DC/DC converter 515 electrically coupled between a first battery interface (e.g., a first battery port) and a second battery interface (e.g., a second battery port). The first battery interface of the electronic device 525 is configured to electrically couple to a first battery 510A of a first type. The second battery interface is configured to electrically couple to a second battery 510 of a second type that is different than the first type. For example, the different types of batteries 510A and 510B were described previously herein with respect to FIGS. 5A and 5B (e.g., different nominal voltages, different charging capabilities, different discharging capabilities, and/or the like). In some instances, the bidirectional DC/DC converter 515 is configured to selectively convert first DC power from the first battery 510A to charge the second battery 510B and convert second DC power from the second battery 510B to charge the first battery 510A.

Although not shown in FIG. 5C, in some instances, the electronic device 525 includes an electronic processor similar to the electronic processor 435 described previously herein. In such instances, the electronic processor may be electrically coupled to the first battery interface, the second battery interface, and the bidirectional DC/DC converter 515. The electronic processor may be configured to determine a characteristic of the first battery 510A and determine a characteristic of the second battery 510B. The electronic processor may be configured to control, based on the characteristic of the first battery 510A and the characteristic of the second battery 510B, the bidirectional DC/DC converter 515 to charge one of the first battery 510A and the second battery 510B using power from the other one of the first battery 510A and the second battery 510B. The characteristic of the first battery 510A and/or the characteristic of the second battery 510B may include any one or a combination of a state of charge of a respective battery 510, a fault status of the respective battery 510, a discharge capability of the respective battery 510, a charge capability of the respective battery 510, a requested charge rate of the respective battery 510, a health of the respective battery 510, and a nominal voltage of the respective battery 510. In some instances, the electronic processor is configured to communicate with the first battery 510A to determine the characteristic of the first battery 510A and communicate with the second battery 510B to determine the characteristic of the second battery 510B. In some instances, the electronic processor is configured to communicate with the first battery 510A and the second battery 510B using a CAN bus. In addition to or as an alternative to communicating with the batteries 510, the electronic processor may receive sensed values from sensors to determine one or more characteristics of the batteries 510.

In the example shown in FIG. 5C, a DC bus (e.g., similar to the DC bus 420 as described previously herein) may not be included in the electronic device 525 since the electronic device 525 is only configured to couple between two battery packs 510A and 510B. In other instances, the electronic device 525 may be configured to couple to more than two battery packs 510. For example, the electronic device 525 may include one or more additional battery pack interfaces (e.g., a third battery pack interface configured to electrically couple to an additional first battery 510A of the first type). The electronic device 525 also may include a DC bus similar to the DC bus 420 described herein and may also include an additional bidirectional DC/DC converter 515 (i.e., a respective bidirectional DC/DC converter 515 for each battery 510 to couple between the respective battery 510 and the DC bus in a similar manner as explained previously herein with respect to FIGS. 5A and 5B). The description of the DC bus 420 herein also applies to the DC bus that may be included in the electronic device 525. In some instances, a first bidirectional DC/DC converter 515 may be electrically coupled between the DC bus and the second battery 510B. A second bidirectional DC/DC converter 515 may be electrically coupled between the DC bus and the additional first battery 510A, and a third bidirectional DC/DC converter 515 may be electrically coupled between the DC bus and the first battery 510A. In some instances, the first bidirectional DC/DC converter 515 is configured to convert DC power received from the second battery 510B to DC power at the DC bus. In some instances, the third bidirectional DC/DC converter 515 is configured to convert DC power from the DC bus to charge the first battery 510A. In some instances, the second bidirectional DC/DC converter 515 is configured to convert DC power from the DC bus to charge the additional first battery 510A.

Because the first type of battery 510A is smaller than the second type of battery 510B in some instances, the electronic device 525 may more commonly have multiple battery interfaces for the first batteries 510A and a single battery interface for the for the second batteries 510B. However, in some instances, the electronic device 525 may additionally or alternatively have multiple battery interfaces (e.g., battery ports) for the second batteries 510B to electrically couple to multiple second batteries 510B. In some instances, the second battery 510B optionally (e.g., as selected by a user via a user input device on a housing of the electronic device 525 or via a command from a user's external device such as a smart phone) simultaneously or sequentially charges multiple first batteries 510A. In some instances, one or more first batteries 510A optionally simultaneously or sequentially charge a second battery 510B. A user input received on the housing of the electronic device 525 or via an external device that communicates wirelessly with the electronic device 525 may also be used to select which batteries 510 are used for charging and which batteries 510 receive charging current.

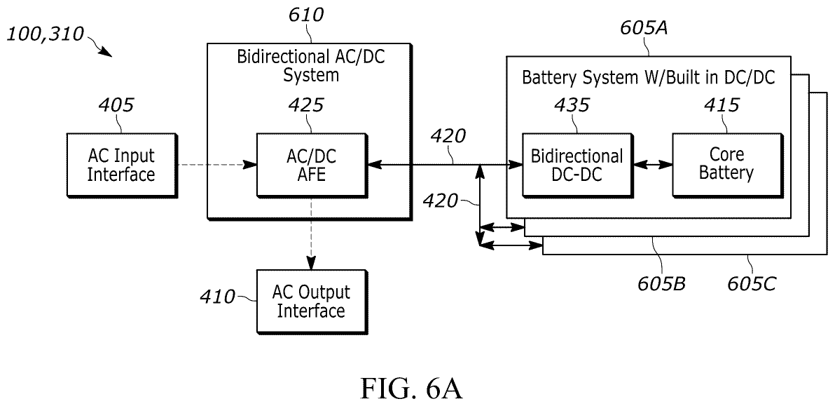

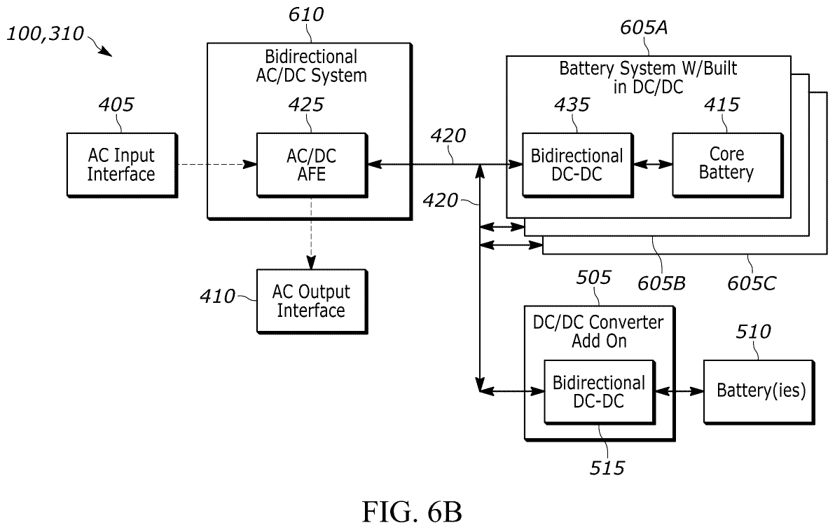

FIG. 6A is a schematic illustration of an alternate embodiment of the electronic device 100, 310 of FIG. 4 that includes a bidirectional DC/DC converter 430 packaged within each of the core batteries 415 as opposed to the bidirectional DC/DC converter 430 being packaged within the bidirectional power converter 130 that also includes the bidirectional AC/DC AFE drive circuit 425 as shown in FIG. 4. Accordingly, as labeled in FIG. 6A, each core battery 415 may be considered to be a battery system 605 that includes a core battery 415 and a bidirectional DC/DC converter 430. In some instances, the electronic device 100, 310 includes a first housing configured to house the bidirectional AC/DC AFE drive circuit 425, and a second housing configured to house the battery 415 and the bidirectional DC/DC converter 430. The bidirectional AC/DC AFE drive circuit 425 and the bidirectional DC/DC converter 430 may be electrically connected to each other via the DC bus 420. In some embodiments, the first housing and the second housing explained immediately above may each form a separate modular device 310 such that two separate modular devices 310 are mechanically and/or electrically coupled together to form the electronic device 100, 310.

In some instances, one or both of a bidirectional AC/DC system 610 and the battery system 605 may include an electronic processor that is similar to the electronic processor 435 explained previously herein. For example, when each system 605 and 610 include an electronic processor, the two electronic processors may function together to perform the functionality described previously herein with respect to the electronic processor 435. The above explanation of the devices and components shown in FIG. 4 applies to FIG. 6A except with respect to the difference in architecture shown in FIG. 6A as explained above. Although FIG. 6A shows three battery systems 605A, 605B, and 605C, in other instances, the electronic device 100, 310 may include additional or fewer battery systems 605.

FIG. 6B is a schematic illustration of the electronic device 100, 310 of FIG. 6A operating in conjunction with a DC/DC converter add-on device 505 to allow a battery pack 510 to connect to the electronic device 100, 310 in a similar manner as shown in FIG. 5A. The above explanations of the devices and components shown in FIG. 4 and in FIG. 6A applies to FIG. 6B. The batteries 510 shown in FIG. 6B may include different types of batteries 510 (e.g., batteries 510A and 510B) and/or different amounts of batteries 510. Each additional battery 510 may be coupled to the DC bus 420 via a respective DC/DC converter add-on device 505 as shown in FIG. 5A.

As explained previously herein with respect to the components of the electronic device 100, 310, power can be transferred between various combinations of the input interface 405, the output interface 410, a core battery(ies) 415, and/or an additional battery(ies)/battery pack(s) 510, for example, via the DC bus 420 (e.g., AC/DC charging of batteries 415, 510, DC/DC charging of batteries 415, 510, simultaneous AC and DC charging of batteries 415, 510, AC output provided from batteries 415, 510 and/or the AC input interface, etc.). Example power transfer control with respect to various situations will now be explained.

With respect to AC/DC charging where AC power from the input interface 405 is used to charge one or more of the batteries 415, 510, the bidirectional AC/DC AFE drive circuit 425 may communicate a total power available for charging the batteries 415, 510 (including the battery systems 605 if included in a given embodiment) to the batteries 415, 510. In some instances, the electronic processor 435 may determine the total power available and/or communicate with the batteries 415, 510. The batteries 415, 510 to be charged negotiate a charge rate with the bidirectional power converter 130 (e.g., with the electronic processor 435). For example, the total charging power is negotiated to be less than or equal to the total power available from the input interface 405. As described previously herein, the bidirectional AC/DC AFE drive circuit 425 receives AC power from an AC source via the input interface 405 and converts the AC power to DC power that is regulated to the DC bus 420 at, for example, 400 Volts. The battery(ies) 415, 510 to be charged and their associated bidirectional DC/DC converter 430 use power from the DC bus 420 to charge themselves at the negotiated charge rate.

With respect to DC/DC charging where DC power from one or more batteries 415, 510 (including the battery systems 605 if included in a given embodiment) is used to charge one or more other batteries 415, 510 the battery 415, 510 to be charged requests, for example, from the electronic processor 435 and/or from the battery 415, 510 to provide DC power for charging, a specific charging rate. The battery 415, 510 to provide DC power for charging (i.e., the charging battery 415, 510) may respond with its charging capabilities, and a charging rate may be agreed upon by the batteries 415, 510. The charging battery 415, 510 and its associated bidirectional DC/DC converter 430 regulate the DC bus voltage (e.g., at 400 Volts). The battery 415, 510 being charged and its associated bidirectional converter 430 use power from the DC bus to charge itself at the agreed upon charging rate. In some instances, during DC/DC charging of one or more of the batteries 415, 510 from another one or more of the batteries 415, 510 charging may occur at power levels greater than 1.8 Kilowatts (e.g., up to 10 Kilowatts).

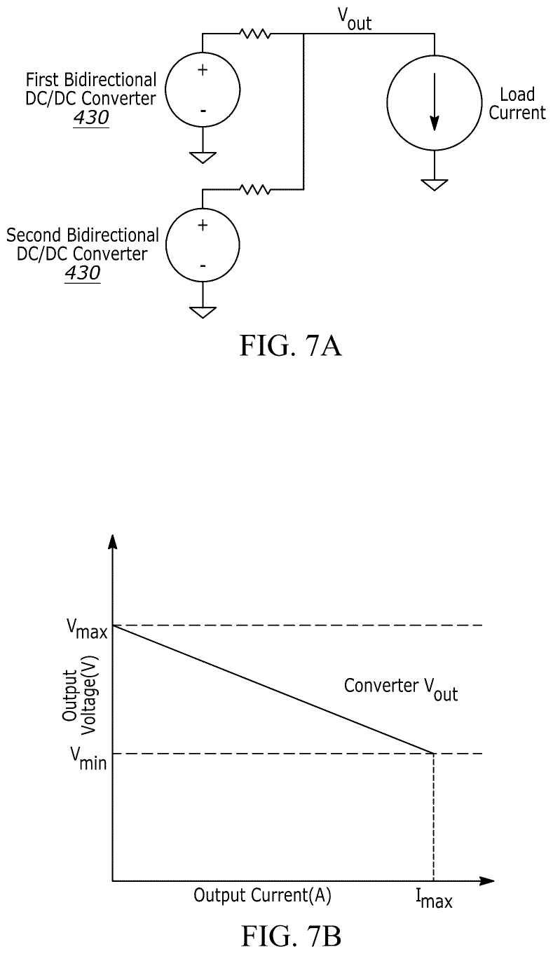

In some instances, multiple batteries 415, 510 may operate in parallel to provide DC power to the DC bus 420 and to regulate the DC bus 420, for example, by utilizing a load slope to share power/facilitate load sharing. In some instances, the load slope makes each converter (e.g., bidirectional DC/DC converters 430 and/or the bidirectional AC/DC AFE drive circuit 425) look like (to each other) a voltage source with a “resistor” in series with the output of each converter (see FIG. 7A). This effect forces the converters 430 to share the load. For example, if a first bidirectional DC/DC converter 430 is delivering more current than a second bidirectional DC/DC converter 430, the first bidirectional DC/DC converter 430 drops its output voltage and the second bidirectional DC/DC converter delivers more of the load current (see FIG. 7B that illustrates a relationship between output voltage and output current of each of the bidirectional DC/DC converters 430 when a load slope is utilized). FIGS. 7A and 7B illustrate the principles of a load slope being used by the converters 430 disclosed herein according to some example embodiments.

In a similar manner as described above with respect to batteries 415, 510 providing DC power to the DC bus 420 and regulating the DC bus 420 to 400 Volts, the AC/DC AFE drive circuit 425 may utilize power from the DC bus to provide AC power to an AC load via the output interface 410. The AC/DC AFE drive circuit 425 may be configured to convert DC power from the DC bus 420 to AC power of a designated magnitude and frequency. In some instances, when an AC power source is connected to the input interface 405, the AC/DC AFE drive circuit 425 may at least partially use AC power from the input interface 405 to provide the AC power that is output via the output interface 410. When the batteries 415, 510 are being used to provide power to the DC bus 420, the batteries 415, 510 may be discharged simultaneously or sequentially (e.g., based on pre-programmed settings of the electronic device 100, 310), based on a user input that selects how the batteries 415, 510 are discharged, and/or the like). Similarly, when at least some batteries 415, 510 are being charged, the batteries 415, 510 may be charged simultaneously or sequentially (e.g., based on pre-programmed settings of the electronic device 100, 310), based on a user input that selects how the batteries 415, 510 are charged, and/or the like).

The DC bus 420 disclosed herein allows for consistent design of bidirectional DC/DC converters 430 since the DC bus 420 is regulated to be at an approximately constant voltage (e.g., 400 Volts). Operating over a smaller range of conversion ratios of the voltage of the DC bus 420 to the voltage of a battery 415, 510 (i.e., V_{DC_BUS}/V_{BATT}) facilitates smaller and more efficient power converter design. Additionally, as explained previously herein, the devices 100, 310, 415, 510, 605, etc. may include communication capabilities (e.g., CAN bus communication capabilities) to communicate with other devices and control power transfer using their respective converters (e.g., drive circuit 425, DC converter 430). In some instances, communication capabilities may be limited or absent and instead the electronic device 100, 310 may determine characteristics of downstream devices using sensors. In some instances, information that is communicated between devices and/or sensed by the electronic device 100, 310 includes a state-of-charge of each battery 415, 510 (including the battery systems 605 if included in a given embodiment); a health of each battery 415, 510; a fault status of each battery 415, 510; a discharge capability of each battery 415, 510; a charge capability of each battery 415, 510; a requested charge rate of each battery 415, 510 and/or a total requested charge rate of multiple batteries 415, 510 connected to the modular ecosystem 300; a requested discharge power from the modular ecosystem 300; a system status (e.g., charging discharging, idle, etc.); and/or the like.

In some instances, any of the bidirectional DC/DC converters 430 disclosed herein may be embodied as an isolated converter or a non-isolated converter. Converters with an isolated topology (i.e., isolated converters) isolate an input from an output by electrically and physically separating the circuit into two sections and preventing direct current flow between the input and the output. Isolated converters may be achieved using a transformer. On the other hand, converters with a non-isolated topology (i.e., non-isolated converters) include a single circuit in which current can flow between the input and the output. There are benefits and tradeoffs with using each type of converter in different situations.

For example, isolated converters allow for a wide voltage conversion ratio without adding additional conversion stages. More specifically, by adjusting the transformer turns ratio of an isolated converter, a 400 Volt to 80 Volt converter can be adjusted to a 400 Volt to 20 Volt converter. Additionally, isolated converters can support 400 Volts and any battery pack voltage with a properly designed transformer. Furthermore, with isolated converters, galvanic isolation prevents single point faults from causing a shock hazard, and there are low touch current levels by design.

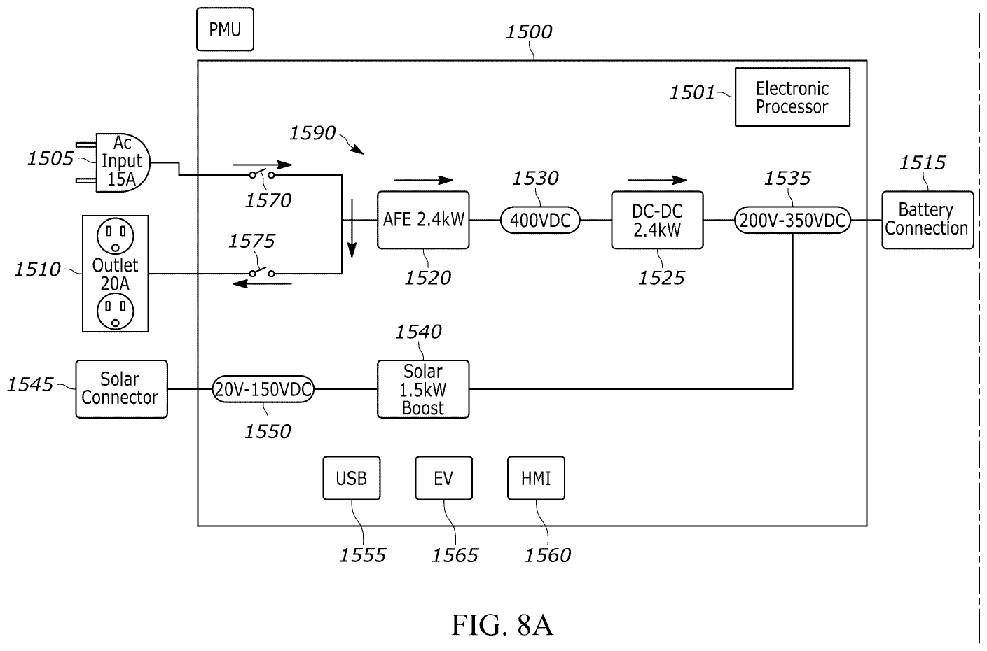

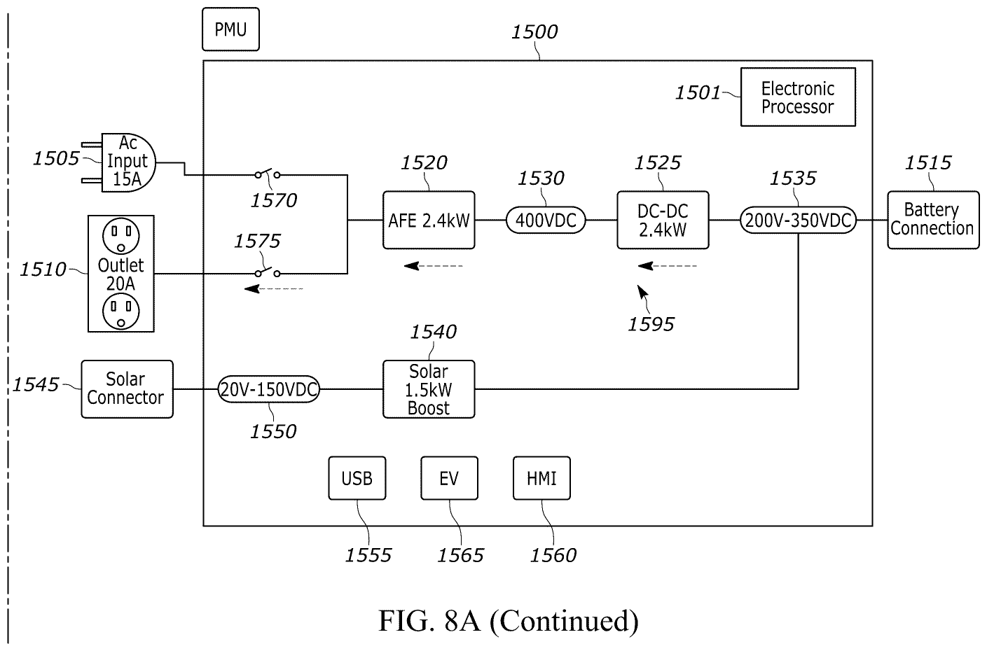

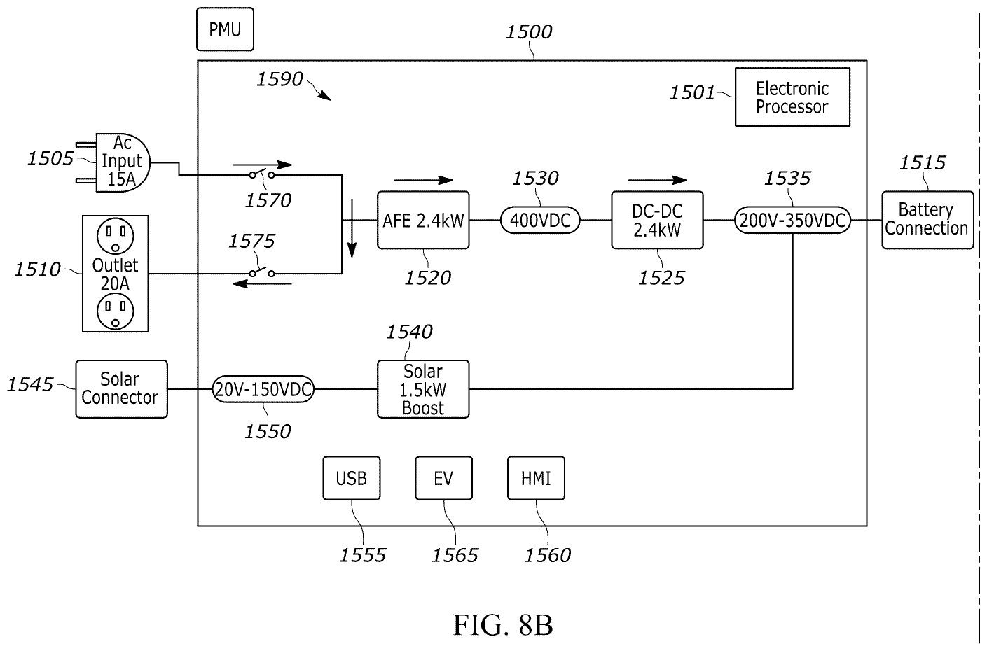

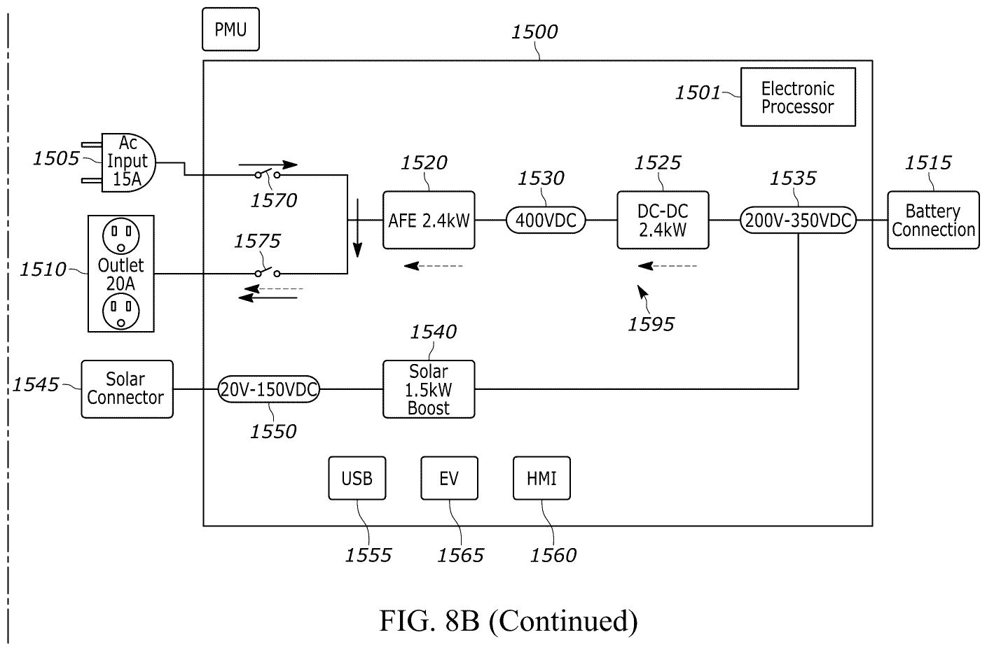

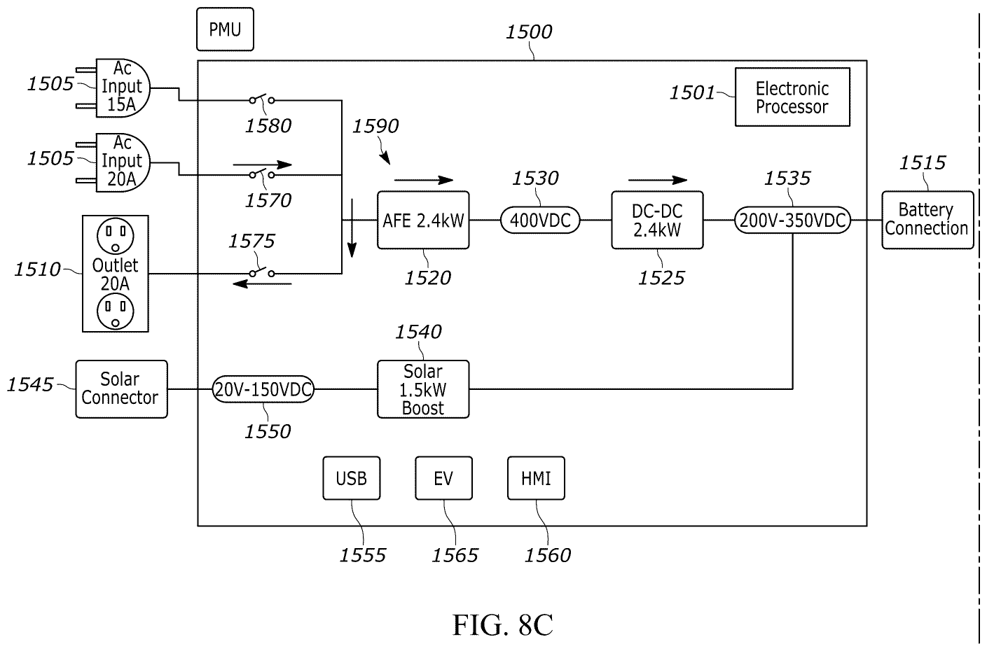

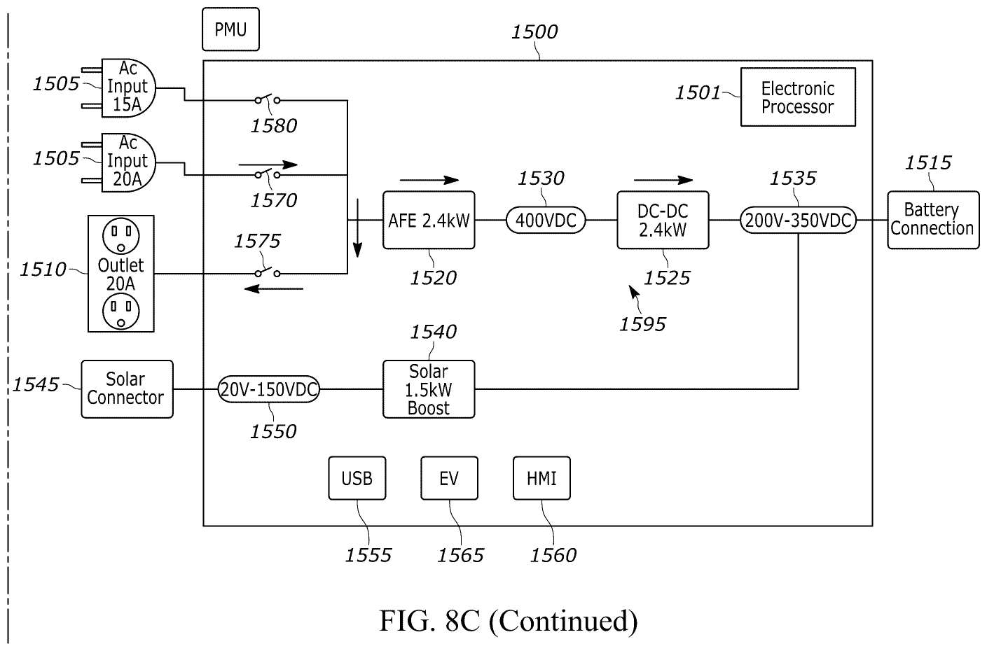

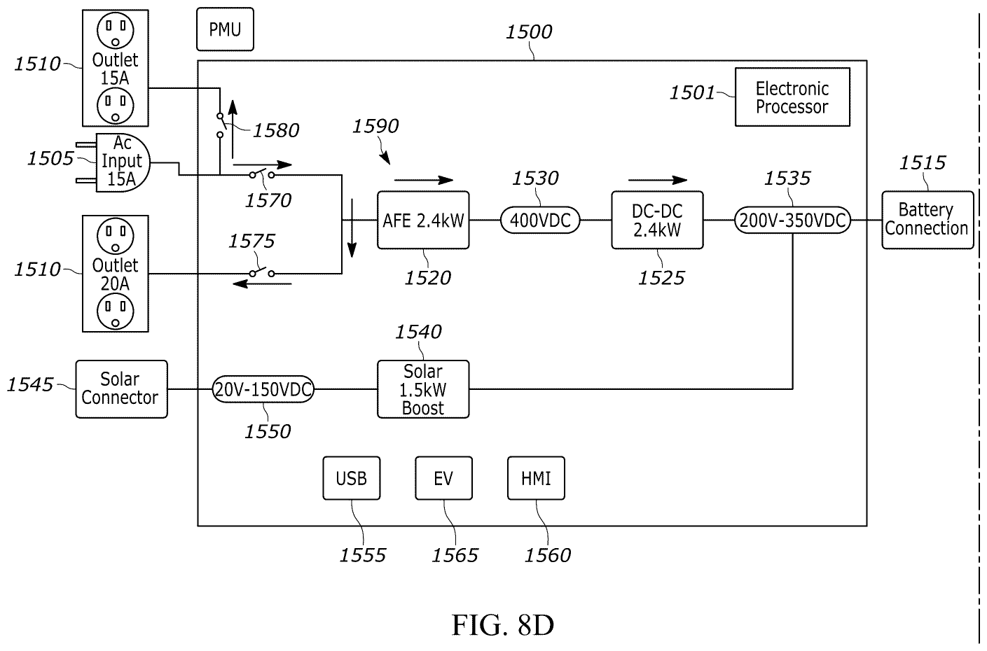

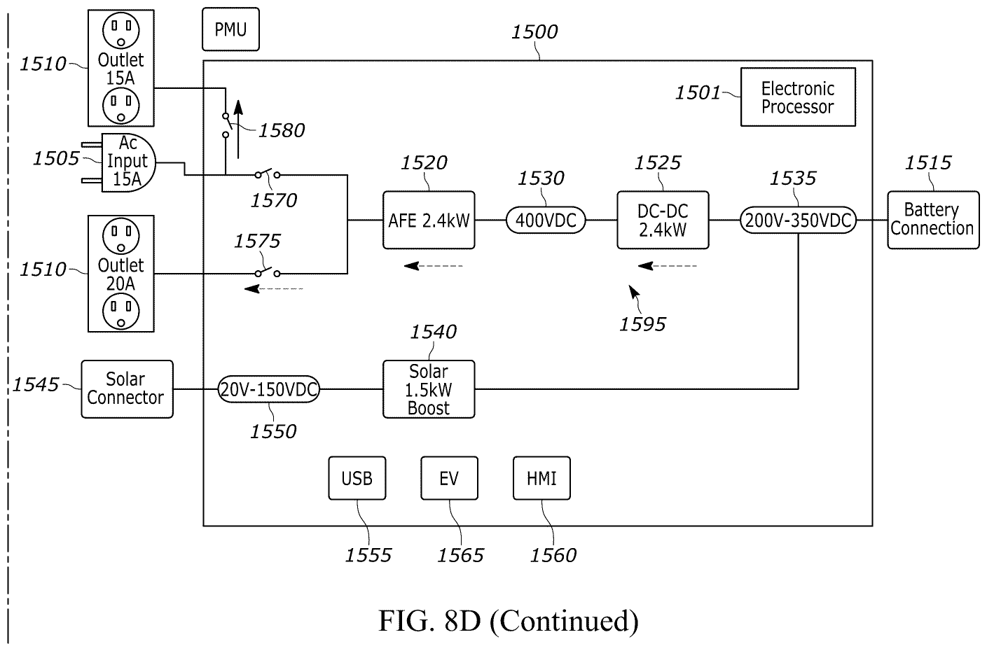

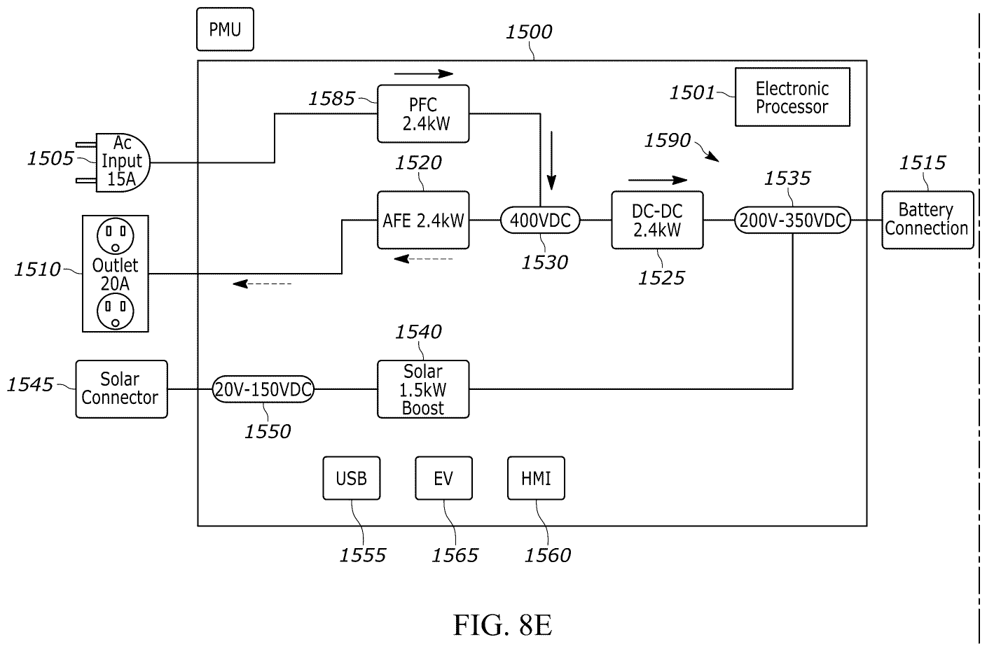

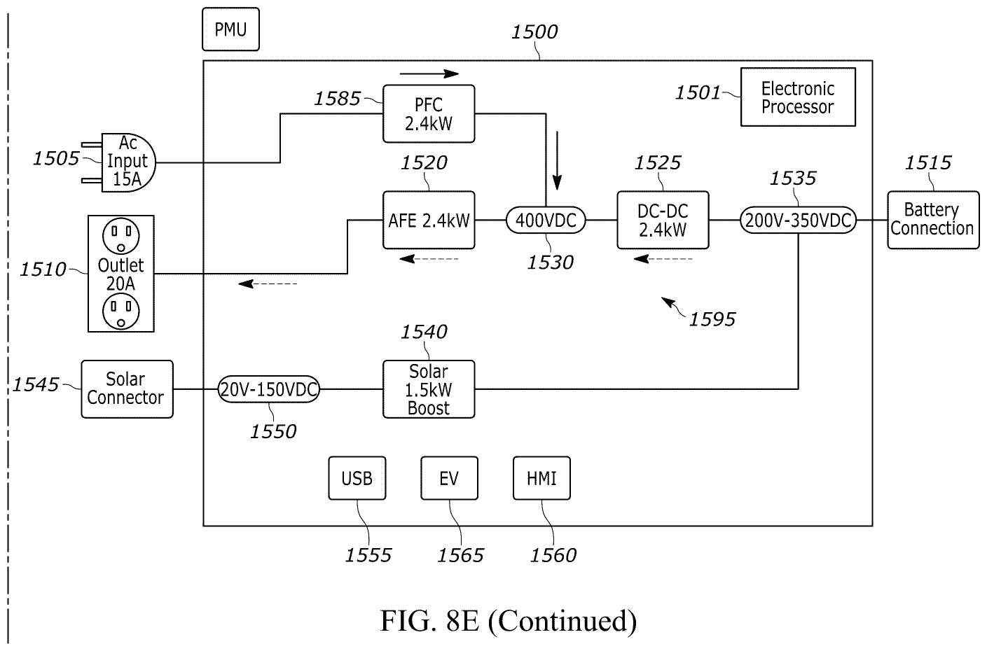

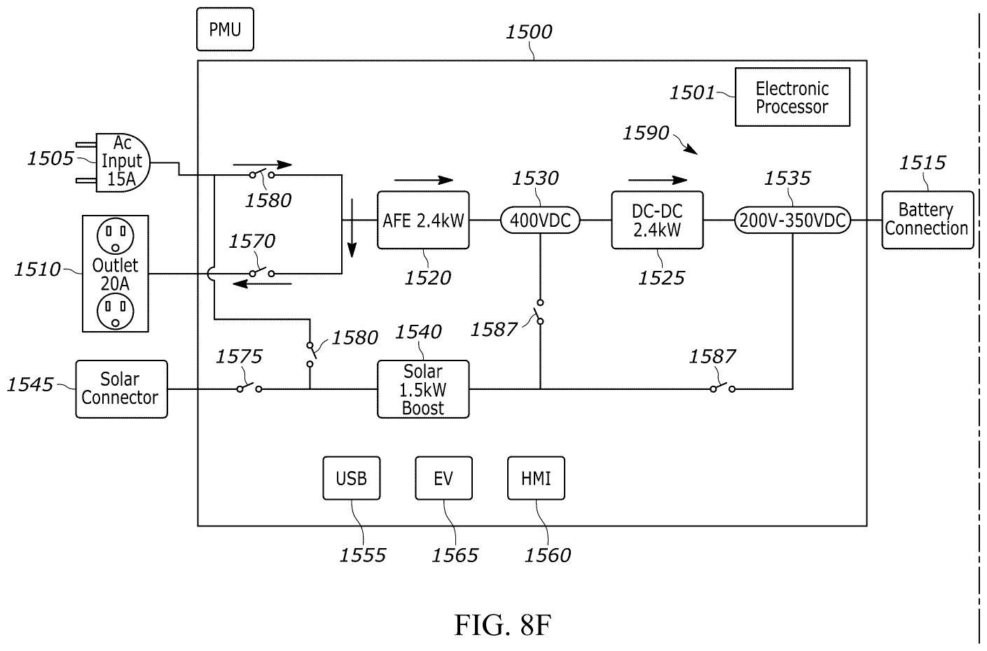

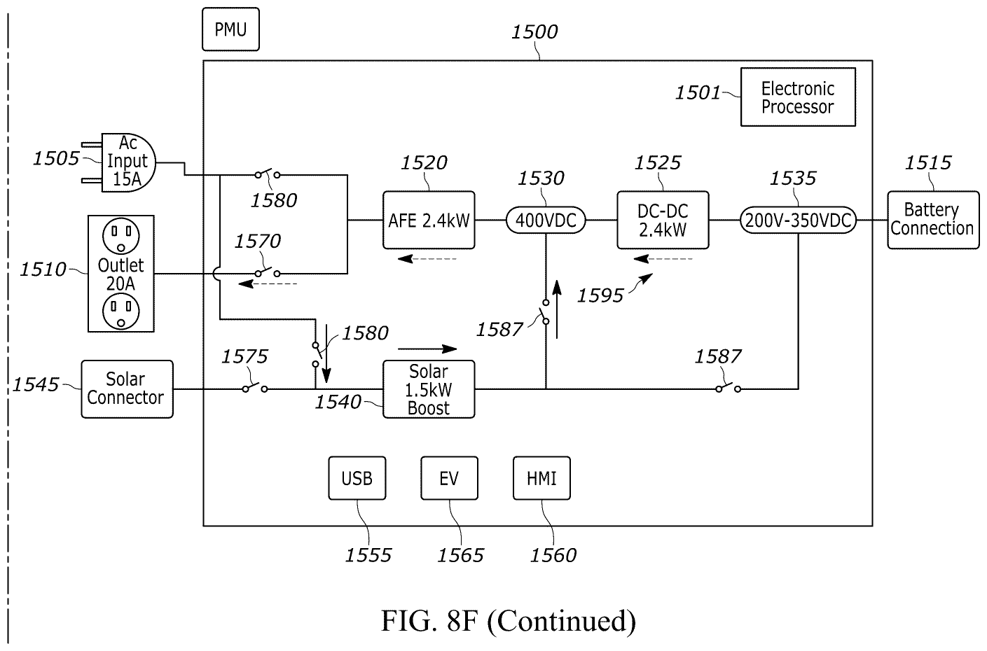

As previously introduced, the bidirectional DC/DC converter 430 utilizes the same hardware to perform both charging and discharging functions. This dual-use architecture presents technical challenges when implementing passthrough functionality, as power conversion hardware can only operate in one direction at a given time. For instance, if the available input power from the AC source (e.g., via input interface 220, 245, 405) is insufficient to meet load demands and the system transitions into discharge mode, the remaining source power becomes unusable, resulting in reduced efficiency and unnecessary battery discharge. To address these challenges and ensure optimal source power utilization, FIGS. 8A-8F illustrate various embodiments and architectural modifications of an electronic device 1500 configured to intelligently manage bidirectional power flow.

FIG. 8A illustrates an embodiment of an electronic device 1500 (also referred to herein as the device 1500) that is structurally and functionally similar to previously described device 100 but includes additional or alternative components to support enhanced power management. As illustrated in FIG. 8A, the device 1500 includes an AC input interface 1505 (e.g., corresponding to input interface 220, 245, or 405), an AC output interface 1510 (e.g., corresponding to output interfaces 225, 250, or 410), and a battery interface 1515 (e.g., interfaces 235A, 235B, or connection to batteries 415, 510). Internally, the device 1500 includes a bidirectional AC/DC active front end (AFE) drive circuit 1520 and a bidirectional DC/DC converter 1525 interconnected via a first DC bus 1530, which is regulated at approximately 400 Volts in some embodiments. A second DC bus 1535 connects the bidirectional DC/DC converter 1525 to the battery interface 1515 and may be regulated between approximately 200 Volts and 350 Volts. The device 1500 may also include an electronic processor 1501 that functions similarly to electronic processor 435. The electronic processor may be connected to the AFE drive circuit 1520 and/or the bidirectional DC/DC converter 1525 in the same way that electronic processor 435 connects with the AC/DC AFE drive circuit 425 and the bidirectional DC/DC converter 430 as described with respect to FIG. 4.

Additionally, a solar boost converter 1540 is coupled to the second DC bus 1535 and connects to a solar interface 1545 via a third DC bus 1550, which may be regulated between 20 Volts and 150 Volts to accommodate various solar panel configurations. The solar boost converter 1540 is configured to regulate the voltage of photovoltaic input to match the required level of the second DC bus 1535 (e.g., a predefined voltage level for battery charging), maximizing power efficiency. In some embodiments, the solar boost converter 1540 works in coordination with AC power, battery power, or a combination thereof to supplement energy to the DC bus or provide priority-based charging to the battery interface 1515. In other words, the solar boost converter 1540 may be configured to charge a battery (electrically connected to the battery interface 1515) when solar power is available. However, the solar boost converter 1540 may also be used to supplement battery power in discharge when solar power is available. The solar boost converter 1540 may also be used (see, e.g., FIG. 8F) as a PFC converter and supplement the AC output and/or battery power with power from AC input. In some embodiments, the solar interface 1545 supports one or more connector standards for compatibility with consumer-grade or commercial solar modules. Peripheral interfaces may also be included, such as, for example, a universal serial bus (USB) interface 1555, a human-machine interface (HMI) 1560, and an electric vehicle (EV) interface 1565 for broader application flexibility.

FIG. 8A further illustrates an operational mode in which the AC input power exceeds the AC output power. In this embodiment, power flows from the AC input interface 1505 through a switch 1570 to the AFE drive circuit 1520. At the AFE drive circuit 1520, power may be directed toward the AC output interface 1510 and routed through the bidirectional DC/DC converter 1525 to charge one or more batteries coupled to the battery interface 1515. Power direction is depicted via arrows 1590 in FIG. 8A. The output switch 1575 may be controlled by the electronic processor 1501 to permit or restrict power delivery to the AC output interface 1510 (e.g., responsive to a monitored state of charge of a battery connected to the battery interface 1515 reaching a threshold charge level to restrict discharge from the connected battery).

In contrast, FIG. 8A also illustrates a condition in which the AC output power demand exceeds the available AC input power. Under this load condition, the device 1500 draws supplemental power from the one or more batteries coupled to the battery interface 1515 through the bidirectional DC/DC converter 1525 and routes the power through the AFE drive circuit 1520 to the AC output interface 1510, as illustrated by power flow arrows 1595 in FIG. 8A. The AC input may be temporarily disabled by the electronic processor 1501 (e.g., by opening the switch 1570) to prioritize battery discharge when AC input contribution is insufficient or below a predetermined threshold.

FIG. 8B depicts an alternative embodiment in which the electronic device 1500 operates in an interactive grid mode. In this configuration, when the AC output demand exceeds AC input availability, the AC input interface 1505 remains enabled (e.g., the switch 1570 closed) to allow the available AC input power to supplement power provided by the battery and DC/DC converter. This hybrid mode enables partial passthrough capability and prevents reliance on battery energy when the grid is under capacity.

FIG. 8C illustrates an embodiment in which the electronic device 1500 includes multiple AC input interfaces 1505, each rated for different maximum current capacities (e.g., one input interface rated at 15 Amps and another input interface rated at 20 Amps). Each interface includes a corresponding input switch (e.g., switches 1570, 1580) controllable by the by the electronic processor 1501 to enable or disable power intake. This configuration supports flexible operation across different power infrastructures, such as residential or industrial sites, with AC input current ratings ranging from 5 Amps to 50 Amps or more. In some examples, the interfaces are also configured to accept lower-than-rated input currents. The two halves shown in FIG. 8C may include identical power flow arrows to illustrate input power available being equal to greater than the output power needs such that the system can power the output from the input as long as input power is available.

FIG. 8D illustrates an embodiment with a plurality of AC output interfaces (also referred to herein as ports) 1510, similarly rated for different output currents (e.g., 15 Amps and 20 Amps). The device 1500 may distribute available power between AC output interfaces 1510, with each interface selectively receiving power from the AC input or the DC/DC converter depending on load conditions and system configuration. In some embodiments, current ratings of AC output interfaces may be user-configurable via software or physical settings. Accordingly, in this embodiment, the electronic processor 1501 may be configured to control power from the AC input interface and the battery interface to select ones of the plurality of AC output interfaces based on, for example a current draw or a predefined load threshold, which may represents a predefined rating or a user-defined parameter.

FIG. 8E illustrates a power factor correction (PFC) circuit 1585, which receives input from the AC input interface 1505 and connects to the first DC bus 1530. The PFC circuit may replace or augment switches 1570, 1580 in regulating power flow. During conditions where AC input exceeds load demand, the PFC circuit 1585 ensures optimized transfer to both the AC output and the battery interface 1515 via the AFE drive circuit 1520 and bidirectional DC/DC converter 1525. Under higher load conditions, the system continues to utilize both AC input and battery energy in tandem, as indicated by arrows 1590 and 1595. In other words, the PFC circuit 1585 allows connection to the DC bus (e.g., a 400 V DC bus) and enables drawing power from AC input regardless of what the output power is.

In some examples, the PFC circuit 1585 optimizes power transfer to both the AC output interface 1510 and the battery interface 1515 by actively regulating the voltage level on the first DC bus 1530 to maintain a desired power efficiency level during periods when AC input power received via AC input interface 1505 exceeds the immediate AC output demand. For example, the PFC circuit 1585 may modulate the input current to match the voltage waveform to reduce harmonic distortion. This modulation by the PFC circuit 1858 provides unity power factor operation of the device 1500, allowing maximum real power transfer from the AC input interface 1505. After the AC power is converted to DC power and stabilized on the first DC bus 1530, the AFE drive circuit 1520 directs the regulated DC power to the AC output interface 1510, and the bidirectional DC/DC converter 1525 transfers power to the battery interface 1515. In some embodiments, the device 1500 coordinates the operation of the PFC circuit 1585 with switching components (e.g., switches 1570, 1580), with additional converters like the solar boost converter 1540, or a combination thereof.

FIG. 8F illustrates an embodiment in which solar integration is enhanced through switches 1587 that selectively couple the solar boost converter 1540 to either the first DC bus 1530 or the second DC bus 1535. This configuration allows dynamic use of solar energy for either battery charging or direct AC output support, depending on AC output demands at the AC output interface 1510, available power at the AC input interface 1505, or a combination thereof. In other words, in the embodiment of FIG. 8F, the solar boost converter 1540 is used as the PFC converter of FIG. 8E when output is more than input power. This configuration of FIG. 8F makes the solar boost converter 1540 a dual use component and eliminates the PFC stage to reduce the size and cost of the device as compared to the embodiment of FIG. 8E.

Turning to non-isolated converters, such converters can be made smaller and more cost-effective than isolated converters when a voltage conversion range between the voltage of the DC bus 420 and a voltage of the battery 415, 510 is within a ratio of 4:0.25 (V_{DC_BUS}:V_{BATT}). If a larger conversion ratio is required outside of 4:0.25, multiple non-isolated converters may be cascaded to achieve the larger conversion ratio.

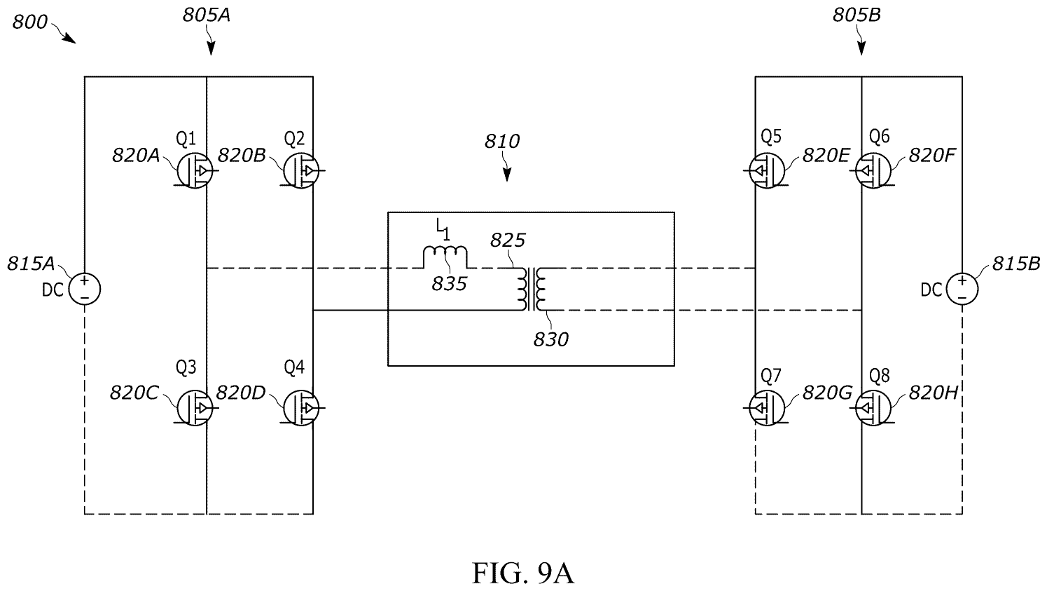

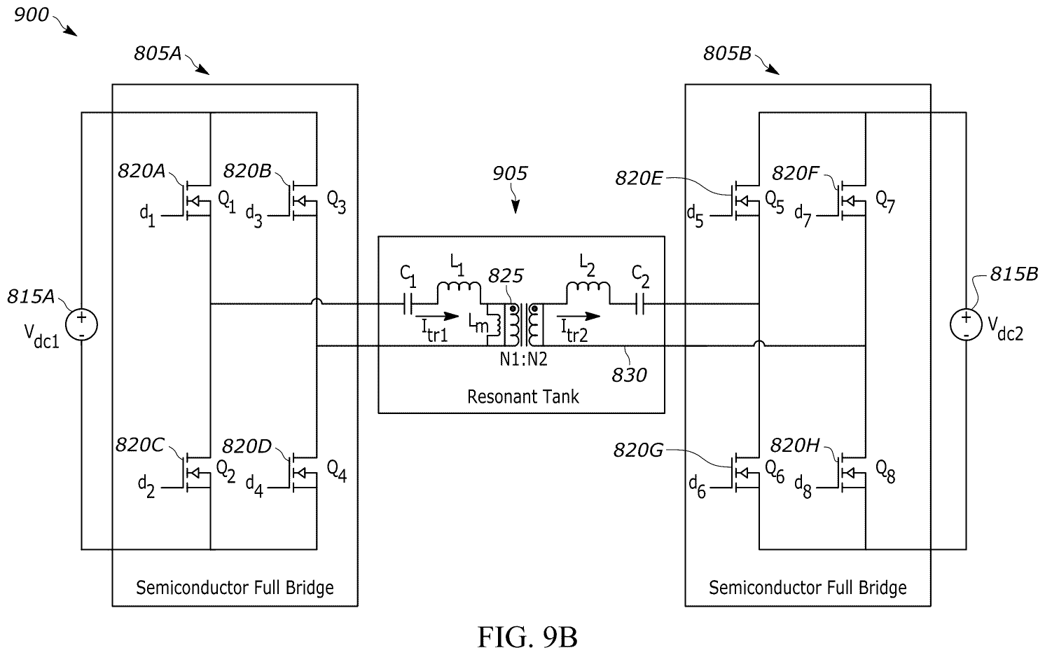

One example of an isolated converter that may be used as the bidirectional DC/DC converter 430 includes a dual active bridge (DAB) 800. FIG. 9A illustrates an example implementation of the DAB 800 that may be used as the bidirectional DC/DC converter 430. The DAB 800 is connected between a battery 415, 510 (represented as the first DC bus 815A in FIG. 9A) and the DC bus 420 (represented as the second DC bus 815B in FIG. 9A) and bidirectionally converts power between the battery 415, 510 and the DC bus 420. For example, the DAB 800 may convert power at a first voltage (e.g., 400 Volts) at the DC bus 420 to a second voltage at the battery 415, 510 corresponding to the charging voltage of the battery 415, 510 to charge the battery 415, 510. The DAB 800 may also convert power at a third voltage (e.g., battery voltage) at the battery 415, 510 to the first voltage (e.g., 400 Volts) at the DC bus 420 that may be converted to AC power to be output by the output interface 410 and/or that may be converted to DC power to charge another battery 415, 510. The DAB 800 includes a first H-bridge 805A, a second H-bridge 805B, and a DAB magnetic structure 810 that includes a transformer electrically connected between the first H-bridge 805A and the second H-bridge 805B.

The first H-bridge 805A is connected to a first DC bus 815A (e.g., the battery 415, 510) and includes four switches 820 provided in an H-bridge configuration. The switches 820 include two high-side switches 820A, 820B electrically connected between a positive terminal of the first DC bus 815A and a first side 825 of the DAB magnetic structure 810 and two low-side switches 820C, 820D electrically connected between a negative terminal of the first DC bus 815A and the first side 825 of the DAB magnetic structure 810. The second H-bridge 805B is connected to a second DC bus 815B (e.g., the DC bus 420 explained previously herein) and includes four switches 820 provided in an H-bridge configuration. The switches 820 include two high-side switches 820E, 820F electrically connected between a positive terminal of the second DC bus 815B and a second side 830 of the DAB magnetic structure 810 and two low-side switches 820G, 820H electrically connected between a negative terminal of the second DC bus 815B and the second side 830 of the DAB magnetic structure 810. In one example, the plurality of switches 820 include metal oxide semiconductor field effect transistors (MOSFETs). In another example, the plurality of switches 820 include wide bandgap (WBG) semiconductor FETs, that is Gallium Nitride (GaN) and/or Silicon Carbide (SiC) based FETs. In yet another example, the plurality of switches 820A-H may include a combination of MOSFETs and wide bandgap semiconductor FETs. The switches 820 are controlled by the electronic processor 435 and/or by an electronic processor associated with each bidirectional DC/DC converter 430 using a gate driver.

The switches 820A-D are electrically connected to an inductor 835 on the first side 825 of the DAB magnetic structure 810. The DAB magnetic structure 810 may be a high-frequency transformer that steps up, steps down, or maintains the voltage between the first side 825 and the second side 830 of the DAB magnetic structure 810. The DAB 800 converts a first voltage at the first DC bus 815A to a second voltage at the second DC bus 815B and vice versa. For example, the first H-bridge 805A converts the first DC voltage at the first DC bus 815A to a first AC voltage at the first side 825 of the DAB magnetic structure 810. The DAB magnetic structure 810 generates a second AC voltage at the second side 830 in response to the first AC voltage. The second H-bridge 805B converts the second AC voltage to the second DC voltage at the second DC bus 815B. A similar process may be used in the opposite direction to convert the second DC voltage to the first DC voltage.

The DAB 800 is controlled by modulating the phase shift (ϕ) . Both H-bridges 805 have a fixed 50% duty cycle and complementary switching. The switching patterns of the first H-bridge 805A and the second H-bridge 805B are then offset in time. In addition to controlling the voltage on either side of the DAB 800, this also allows for bidirectional power flow. For example, when the phase shift has a polarity greater than zero, power flows from the first DC bus 815A to the second DC bus 815B. On the other hand, when the phase shift has a polarity less than zero, power flows from the second DC bus 815B to the first DC bus 815A.

The DAB 800 (operating as the bidirectional DC/DC converter 430) in conjunction with the bidirectional AC/DC AFE drive circuit 425 enables reduction of electronic assemblies in the electronic device 100, 310 by combining charger functionality and inverter functionality into a single assembly, which provides size (i.e., smaller size), weight (i.e., lower weight), and cost (i.e., lower cost) advantages. Additionally, the DAB 800 has a wide voltage conversion range. With a properly designed transformer there is very little limitation on what voltage range can be achieved compared to a typical duty cycle-controlled converter, which can have challenges or performance reduction for very high or very small voltage conversion ratios.

Accordingly, a single topology may be used for many different types of batteries 415, 510 (e.g., 12-Volt batteries, 18-Volt batteries, 72-Volt batteries, 100-Volt batteries, etc.). Furthermore, the DAB 800 is capable of soft switching over a wide range. This range can be optimized for the voltage range and load range of most importance for a given application/situation to ensure high efficiency across the operating range. The efficiency of the DAB 800 can be further enhanced through the usage of wide bandgap (WBG) semiconductors. In some instances, WBG semiconductors allow for switching speeds between 100-400 KHz (compared to witching speeds that are usually below 100 KHz for MOSFETs) with less ON resistance than MOSFETs.

The high efficiency of the DAB 800 has benefits when it comes to ensuring the most possible energy from a large-format, energy storage core battery 415 (e.g., 100-Volt core battery) is transferred to smaller, portable batteries (e.g., 18-Volt battery packs configured to couple to a power tool configured for single hand use, 72-Volt battery packs configured to couple to larger power tools and/or outdoor equipment, etc.). This efficient energy transfer is beneficial for portable power products (e.g., portable power source 100A, 100B) where the predominant use case is using a large battery 415 to recharge smaller batteries 510. Additionally, the high efficiency of the DAB 800 has benefits for power tool-like applications where higher efficiency translates to a smaller, more compact solution because, for example, handheld power tools have limited space in which circuitry may be housed while still maintaining the light weight and maneuverability of the power tool.

Another example of an isolated converter that may be used as the bidirectional DC/DC converter 430 includes a CLLC resonant converter 900 (e.g., a Capacitor-Indunctor-Inductor-Capacitor resonant converter). FIG. 9B illustrates an example implementation of the CLLC converter 900 that may be used as the bidirectional DC/DC converter 430. The CLLC converter 900 shares many of the same components as the DAB 800 as indicated by like reference numbers between FIGS. 8A-8F and FIGS. 9A and 9B. For example, the CLLC converter 900 includes two H-bridges 805 and two DC buses 815 as explained with respect to the DAB 800 of FIG. 9A. The above explanations of the components of the DAB 800 shown in FIG. 9A also applies to the like-named/numbered components of FIG. 9B. However, instead of including the DAB magnetic structure 810 between the two H-bridges 805 as is shown in FIG. 9A, the CLLC converter 900 includes a resonant tank 905. In some instances, the resonant tank 905 includes a transformer and various capacitors (C₁, C₂) and inductors (L₁, L₂, Lₘ) as shown in FIG. 9B.

The CLLC converter 900 is controlled by modulating the switching frequency (f_{sw}).

Similar to the DAB 800, both of the two H-bridges 805 have a fixed 50% duty cycle and complementary switching. The frequency where the CLLC converter 900 operates changes the frequency-dependent gain of the resonant tank 905, which allows for control over output voltage or current. Parameter variation in the resonant tank 905 results in different, frequency-dependent gain curves for the CLLC converter 900. Different applications (e.g., different battery ranges, different power ranges, etc.) may require different gain curves.

The CLLC converter 900 provides many of the same advantages/benefits as the DAB 800 that were explained previously herein with respect to the DAB 800. For example, like the DAB 800, the CLLC converter 900 is bidirectional and is capable of soft switching. The CLLC converter also enables many of the same size, weight, and cost benefits. On the other hand, the operating range of the CLLC converter 900 is not as wide as the DAB 800. While this reduced operating range can be overcome by using a multi-stage design, the CLLC converter 900 may be less applicable for single-stage designs. However, due to high battery core voltages (e.g., of battery 415), many portable power products (e.g., portable power source 100A, 100B) already require a multi-stage design. Thus, for such products, the impact of the reduced operating range of the CLLC converter 900 is lessened. Additionally, the CLLC converter 900 has a narrow range where it is very efficient, even more efficient than the DAB 800. Accordingly, for applications that fall within this narrow range of increased efficiency, the CLLC converter 900 may be used. Furthermore, a low-load efficiency of the CLLC converter 900 is better than the DAB 800. An increased low-load efficiency is beneficial for applications with a long-runtime but low-power. For example, long-runtime but low-power applications may include lighting, charging a large number of batteries sequentially, and/or the like as opposed to shorter-runtime higher-power applications such as powering a power tool motor, simultaneously charging many batteries, and/or the like.

Performance of the CLLC converter 900 is determined at least partially by the design of the resonant tank 905. This allows for design variants by keeping much of the design the same but adjusting the resonant capacitors/inductors included in the resonant tank 905. Accordingly, different products (e.g., electronic devices 100, 310; power tools; area lights; and/or the like), using the same batteries, can be optimized for different purposes (e.g., a product with lower peak efficiency but higher average efficiency for a design used for multiple battery platforms). Along similar lines, quicker product design cycles can be achieved by merely varying the resonant capacitors/indicators included in the resonant tank 905 for different products/applications.

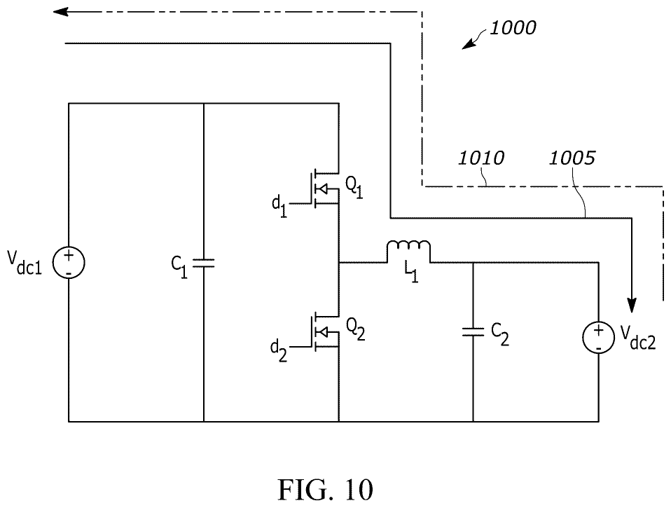

One example of a non-isolated converter that may be used as the bidirectional DC/DC converter 430 includes a buck or boost converter 1000. FIG. 10 illustrates an example implementation of the buck or boost converter 1000 that may be used as the bidirectional DC/DC converter 430. As shown in FIG. 10, the buck or boost converter 1000 includes power sources V_{dc1} and V_{dc2} similar to the two DC buses 815 of the isolated converters as described with respect to the DAB 800 and the CLCC converter 900. The buck or boost converter 1000 also includes capacitors C₁, C₂, an inductor L₁, and switches Q₁, Q₂ as shown in FIG. 10.

In some instances, the power source V_{dc1} includes the DC bus 420 or another high voltage bus distributed throughout a system (e.g., a modular ecosystem 300). In some instances, the power source V_{dc2} includes one of the batteries 415, 510 (e.g., an energy storage battery). In FIG. 10, an arrow 1005 indicative of the converter 1000 operating in a “Buck” mode shows voltage being stepped down from V_{dc1} to V_{dc2}, for example, to charge the battery 415, 510 from the DC bus 420. On the other hand, an arrow 1010 indicative of the converter 1000 operating in “Boost” mode shows voltage being stepped up from V_{dc2} to V_{dc1}, for example, to provide power from the battery 415, 510 to the DC bus 420 so that the power can be distributed elsewhere in the system (e.g., to other devices and/or components in the modular ecosystem 300).

The buck or boost converter 1000 is typically used as a unidirectional converter.

However, digital controls may be implemented to enable bidirectional operation. The voltage range of the converter 1000 is constrained by the topology. For example, with the topology shown in FIG. 10, voltage steps down left to right and steps up right to left. In certain applications (e.g., a DC-DC converter integrated within a battery core 415), using the buck or boost converter 1000 may lead to a reduction in the number of downstream converters needed to charge batteries or provide AC output power. In some instances, a non-isolated topology such as the buck or boost converter 1000 may be used in applications where a user is protected from electrical shock by mechanical design. In some instances, a non-isolated topology such as the buck or boost converter 1000 confers further size (i.e., smaller), weight (i.e., lighter), and cost (i.e., more cost-effective) benefits compared to using an isolated converter.

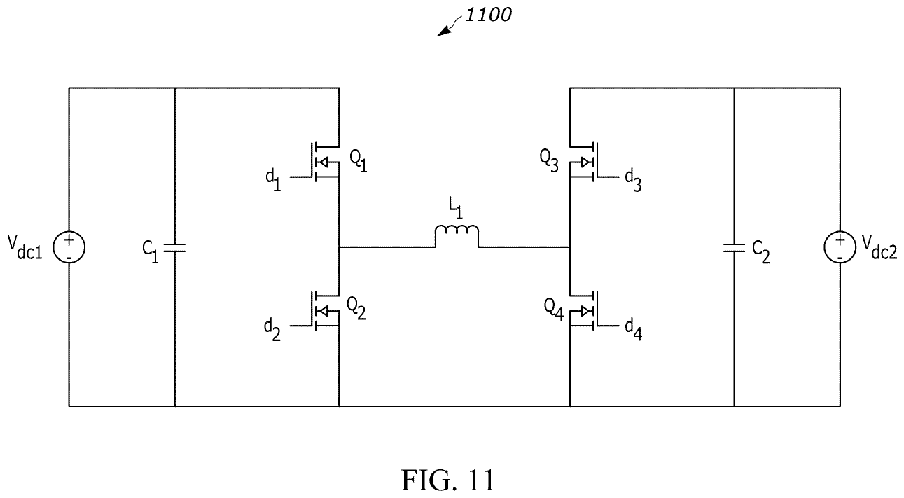

Another example of a non-isolated converter that may be used as the bidirectional DC/DC converter 430 includes a buck and boost (buck-boost) converter 1100. FIG. 11 illustrates an example implementation of the buck-boost converter 1100 that may be used as the bidirectional DC/DC converter 430. As shown in FIG. 11, the buck-boost converter 1100 includes power sources V_{dc1} and V_{dc2} similar to the like-named power sources of the buck or boost converter 1000 of FIG. 10. The buck-boost converter 1100 also includes capacitors C₁, C₂, an inductor L₁, and switches Q₁, Q₂. Q₃, and Q₄ as shown in FIG. 11.

Switches Q₁ and Q₂ are active when V_{dc1} is greater than V_{dc2}. On the other hand, switches Q₃ and Q₄ are active when V_{dc1} is less than V_{dc2}. The buck-boost topology is capable of both stepping up voltage and stepping down voltage. Accordingly, the buck-boost converter 1100 may be used for DC/DC charging/conversion for a large energy storage battery (e.g., battery 415, 510). The buck-boost topology is typically a unidirectional topology but may be made bidirectional via controls and communications throughout the system (e.g., the modular ecosystem 300). The buck-boost converter 1100 may be less cost-effective than a buck or boost converter 1000 (FIG. 10). However, the buck-boost converter 1100 confers benefits by allowing for further reduction in the number of other power electronic converters in the system (e.g., the downstream in the modular ecosystem 300) because of the increased voltage range of the buck-boost topology compared to the buck or boost topology of FIG. 10. The other benefits of non-isolated converters as explained previously herein with respect to FIG. 10 also apply to the buck-boost converter 1100.

The converters explained above with respect to FIGS. 8A-11 are merely examples. The usage of a certain converter for a given electronic device 100, 310 and/or product/application depends on characteristics of the given situation (e.g., product needs, voltage ranges, safety requirements, etc.). In some instances, different electronic devices 100, 310 within a modular ecosystem 300 may include different types of bidirectional DC/DC converters 430. In some instances, a variety of other variations of the disclosed converter topologies may be used as the bidirectional DC/DC converter 430. For example, additional isolated topologies include an LLC or LCC converter that may be used as the bidirectional DC/DC converter 430. These converters respectively lack the capacitor C₂ or the inductor L₂ shown in FIG. 9B. LLC converters and LCC converters are not typically bidirectional but may be made bidirectional with digital controls. However, they may experience reduced performance in one direction of power flow. As another example of an isolated topology, a full bridge or phase-shifted full bridge may be used as the bidirectional DC/DC converter 430. These bridges are typically unidirectional but may be made bidirectional with digital controls. As yet another example of an isolated topology, a multi-phase DAB may be used as the bidirectional DC/DC converter 430. The multi-phase DAB may include the DAB 800 of FIG. 9A with additional parallel phases to increase power handling. Additional non-isolated topology examples include adding additional phases and interleaving either of the converters 1000, 1100 to allow for straightforward power scaling and potential low-load efficiency improvements through phase shedding. As another example of a non-isolated topology, cascading converters together may allow the system to handle very wide voltage conversion ranges. Cascading converters may be most applicable for integration into a low S-count (series) but high P-count (parallel) battery 415, 510 (e.g., 3S50P (i.e., 50 strings of 3 series battery cells connected in parallel)).

In some instances, the bidirectional DC/DC converter 430 that interfaces with a battery 415, 510 is cascaded with a DC-AC converter (e.g., the bidirectional AC/DC AFE drive circuit 425) to produce AC voltage output via the output interface 410 as explained previously herein (see FIGS. 4-6B). With such an arrangement, ripple from the AC voltage output may put undue stress on the bidirectional DC/DC converter 430. To mitigate this stress on the bidirectional DC/DC converter 430, in some instances, averaging control may be added to the bidirectional DC/DC converter 430 (e.g., averaging control may be implemented by the electronic processor 435). This averaging control may be achieved by forcibly limiting the bandwidth of the bidirectional DC/DC converter 430 when feeding the bidirectional AC/DC AFE drive circuit 425 such that the bidirectional DC/DC converter 430 only provides the “average”output power.

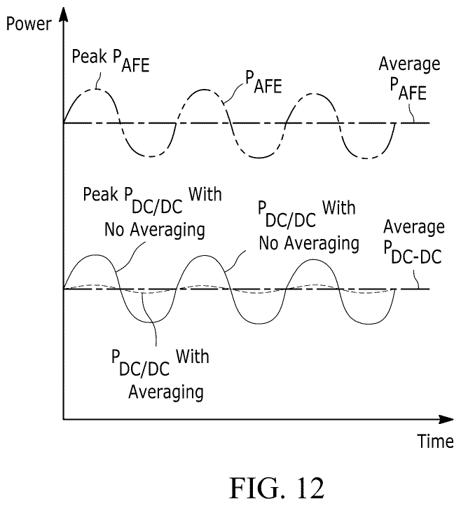

FIG. 12 illustrates a graph of AC output power (P_{AFE}) provided by the bidirectional AC/DC AFE drive circuit 425 to the output interface 410 over time. FIG. 12 also illustrates a graph of DC/DC output power (P_{DC/DC}) provided by the bidirectional DC/DC converter 430 to the bidirectional AC/DC AFE drive circuit 425 over time. As shown in FIG. 12, the peak P_{AFE} is roughly 1.4 times the average P_{AFE}. Similarly, the peak P_{DC/DC} without averaging may reach up to 1.55 times the average P_{DC/DC}. Accordingly, the bidirectional DC/DC converter 430 may be designed to be oversized to handle this peak P_{DC/DC} when averaging is not used. However, when averaging is used, the DC/DC output power (P_{DC/DC} with averaging) provided by the bidirectional DC/DC converter 430 to the bidirectional AC/DC AFE drive circuit 425 has peaks that are significantly smaller. Accordingly, using averaging control in the bidirectional DC/DC converter 430 results in reduced component stress on the bidirectional DC/DC converter 430, which results in cost, size, and weight savings because the bidirectional DC/DC converter 430 may be smaller and designed for a lower power.

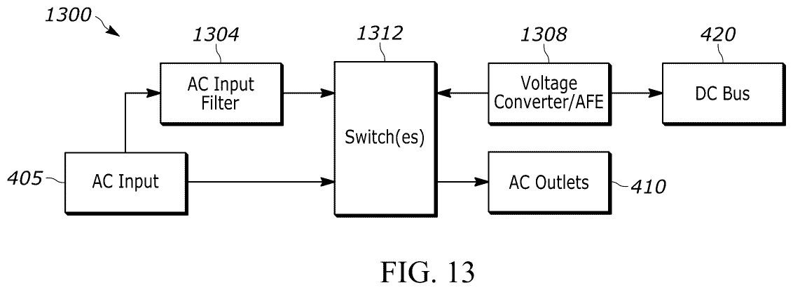

FIG. 13 is a block diagram of a power system circuit 1300 of the electronic device 100, 310 according to some embodiments. Some components of the power system circuit 1300 provide an example of a circuit that may act as the bidirectional AC/DC AFE drive circuit 425 in some example embodiments as explained herein. For example, the AC input filter 1304, the switch(es) 1312, and the voltage converter 1308 may embody the bidirectional AC/DC AFE drive circuit 425 in some instances. The power system circuit 1300 includes the input interface 405, an AC input filter 1304, a voltage converter 1308, the DC bus 420, and the output interface 410. In some embodiments, the AC input filter 1304 is an electromagnetic interference (“EMI”) filter 1304 electrically connected between the input interface 405 and the voltage converter 1308. The EMI filter 1304 provides filtering from the AC input to reduce conducted and radiated emissions in the power system circuit 1300. The voltage converter 1308 may be an active front end (“AFE”) drive circuit (i.e., AFE voltage converter 1308). The AFE voltage converter 1308 is configured to provide bidirectional power exchange to and from the DC bus 420. For example, the AFE voltage converter 1308 can be configured to operate as a rectifier in order to provide power to the DC bus 420 with power supplied by the input interface 405 and can be configured to operate as an inverter in order to discharge power from the DC bus 420 to the output interface 410. The power system circuit 1300 further includes at least one switch 1312 (e.g., a transistor, a toggle switch, an electrical switch, a mechanical switch, a relay, etc.) configured to electrically connect components of the power system circuit 1300. In some embodiments, the power system circuit 1300 provides for a reduced size, weight, and cost of the inverter system for the electronic device 100, 310 because providing power to the DC bus 420 and drawing power from the DC bus 420 can be achieved using the same switching devices and an inductor, as described below. By reducing the components in the electronic device 100, 310, less thermal management is also required. In some embodiments, the electronic device 100, 310 is configured to operate as an uninterruptable power supply (UPS).

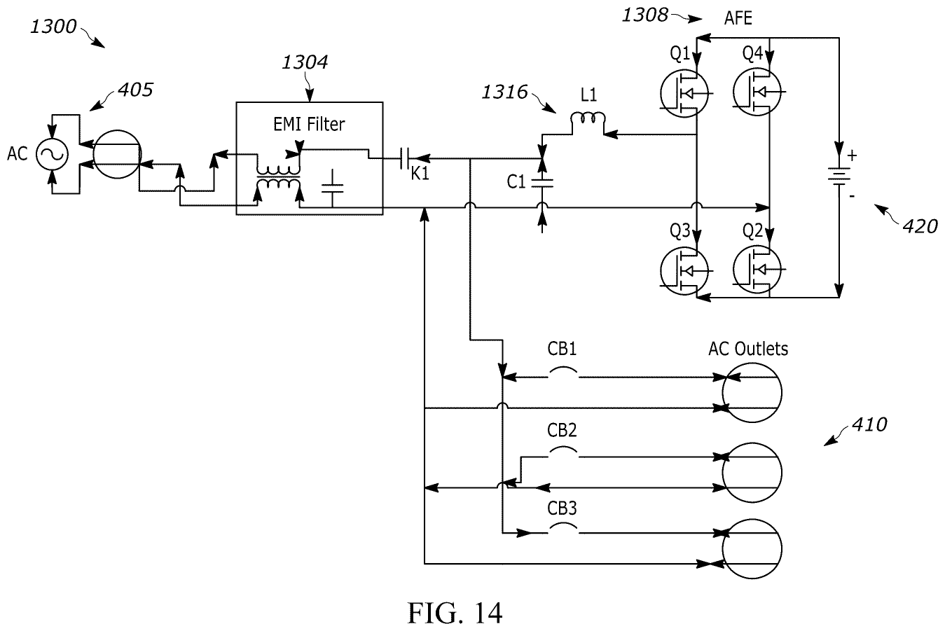

FIG. 14 is a schematic diagram of a first topology of the power system circuit 1300 of FIG. 13. The at least one switch 1312 includes a first switch K1. In some embodiments, the at least one switch 1312 is a relay. The first switch K1 is electrically connected between the output of the EMI filter 1304 and the AFE voltage converter 1308 in order to selectively provide power from the input interface 405 to the DC bus 420. The AFE voltage converter 1308 includes a plurality of transistors (e.g., insulated-gate bipolar transistors) Q1, Q2, Q3, Q4 arranged in a bridge (e.g., an H-bridge) topology. An output filter 1316 (e.g., a sine wave filter) is connected to the AFE voltage converter 1308 in order to provide low total harmonic distortion (“THD”) of the AC power output from the AFE voltage converter 1308. The output filter 1316 may be a sinusoidal filter, and includes at least one capacitor C1 (e.g., a sine wave filter capacitor) and at least one inductor L1. Each of the output interface 410 may include a respective one of a plurality of circuit breakers CB1, CB2, CB3 to protect an external device from damage that may be caused by an overcurrent event. In the illustrated embodiment, the power system circuit 1300 includes three output interfaces 410 configured as AC power outlets. However, the number of power outlets is not limited to three and may be more than three or less than three.

The first switch K1 is controlled by the electronic processor 435 and enables the electronic device 100, 310 to operate in, for example, an AC bypass mode, an AC passthrough mode, a DC discharge mode, DC/DC charging mode, or combinations thereof. In some embodiments, additional modes of operation are included.

When operating in the AC bypass mode, the first switch K1 is closed and the AFE voltage converter 1308 is disabled. As a result, AC power flows directly from the input interface 405 to the output interface 410.

When operating in AC passthrough mode, the first switch K1 is closed and the AFE voltage converter 1308 is enabled to provide power to the DC bus 420. The AC passthrough mode may alternatively be referred to herein as a charge mode for providing power to the DC bus 420 (e.g., to charge batteries 415, 510 that are also connected to the DC bus 420). AC power also still flows directly from the input interface 405 to the output interface 410.

When operating in the DC discharge mode, the first switch K1 is open to disconnect the input interface 405 from the power system circuit 1300, and the AFE voltage converter 1308 is enabled to provide power from the DC bus 420 to the output interface 410. When operating in DC/DC charging mode, the first switch K1 is open and the AFE voltage converter 1308 is disabled. No power is provided to the output interface 410, but power may be exchanged between batteries 415, 510 connected to the DC bus 420 as explained previously herein.

The following are examples of the invention described herein. It should be understood that any of the examples may be combined to include some or all of the features of any other example. Likewise, any of the features of the illustrations as described herein may be included in any combination with any of the examples.

Example 1. An electronic device comprising: an alternating current (AC) input interface; an AC output interface; a direct current (DC) bus; a battery interface; a bidirectional AC/DC active front end (AFE) drive circuit electrically connected between the AC input interface, the AC output interface, and the DC bus, wherein the bidirectional AC/DC AFE drive circuit is configured to convert AC power from the AC input interface to DC power at the DC bus and convert DC power from the DC bus to provide AC power at the AC output interface; a bidirectional DC/DC converter electrically connected between the DC bus and the battery interface, the bidirectional DC/DC converter configured to convert DC power received from a battery electrically connected to the battery interface to DC power at the DC bus and convert DC power from the DC bus to charge the battery; an output switch between the AFE drive circuit and the AC output interface; and an electronic processor configured to: determine a difference in a power level available at the AC input power and a power demand at the AC output interface; and in response to the power demand at the AC output interface being greater than or equal to the power level available at the AC input power, close the output switch and control the AFE drive circuit and the bidirectional DC/DC converter to provide AC output power at the AC output interface.

Example 2. The electronic device of example 1, further comprising an input switch between the AC input interface and the AFE drive circuit, wherein the electronic processor is further configured to selectively open or close the input switch based on the power level available at the AC input interface.

Example 3. The electronic device of example 2, wherein the electronic processor is configured to selectively open or close the input switch by maintaining the input switch in a closed state when the power level available at the AC input interface is below the power demand at the AC output interface to enable a supplemental AC output power from both the AC input and the battery interface.

Example 4. The electronic device of example 1, further comprising a plurality of AC input interfaces, each of the plurality of AC input interfaces rated for a different maximum current level, and wherein the electronic processor is configured to select one of the plurality of the AC input interfaces based on an available input current.

Example 5. The electronic device of example 1, wherein the AC output interface is one of a plurality of AC output interfaces, each of the plurality of AC output interfaces configured to provide a different maximum output current, wherein the electronic processor is configured to direct output power to one of the plurality of AC output interfaces based on the power level available at the AC input interface and a battery charge state.

Example 6. The electronic device of example 1, further comprising a power factor correction (PFC) circuit electrically connected between the AC input interface and the DC bus, wherein the electronic processor is configured to control the PFC circuit to maintain a desired voltage level at the DC bus when converting power from the AC input interface.

Example 7. The electronic device of example 1, further comprising a solar boost converter coupled to the battery interface and configured to receive power from a solar interface, the solar boost converter configured to regulate photovoltaic voltage to meet a predefined voltage level for battery charging.

Example 8. The electronic device of example 1, wherein in response to the power demand at the AC output interface being less than the power level available at the AC input power, the electronic processor is further configured to open the output switch and control the AFE drive circuit and the bidirectional DC/DC converter to provide DC power output at the battery interface.

Example 9. The electronic device of example 1, wherein the electronic processor is further configured to monitor a state of charge of the battery and, in response to the battery reaching a threshold charge level, restrict discharge from the battery.

Example 10. The electronic device of example 1, wherein the DC bus is regulated to a voltage between 200 Volts and 400 Volts, and the electronic processor is further configured to maintain the regulation during transitions between operating modes, the operating modes including providing power from the battery interface and providing power to the battery interface.

Example 11. A method of controlling an electronic device including an AC input interface, an AC output interface, a DC bus, a battery interface, a bidirectional AC/DC active front end (AFE) drive circuit, a bidirectional DC/DC converter, and an electronic processor, the method comprising: determining, via the electronic processor, a difference between a power level available from the AC input interface and a power demand at the AC output interface; and in response to determining that the power demand at the AC output interface is greater than or equal to the power level available at the AC input interface: controlling, via the electronic processor, an output switch between the AFE drive circuit and the AC output interface to a closed state; and controlling, via the electronic processor, the AFE drive circuit and the bidirectional DC/DC converter to provide supplemental AC output power at the AC output interface using stored energy from a battery electrically connected to the battery interface.

Example 12. The method of example 11, further comprising: in response to determining that the power demand at the AC output interface is less than the power level available at the AC input interface: controlling, via the electronic processor, the output switch to an open state; and controlling the AFE drive circuit and the bidirectional DC/DC converter to provide DC power from the AC input interface to the battery interface to charge the battery.

Example 13. The method of example 11, further comprising: monitoring, via the electronic processor, a voltage level of the DC bus; and adjusting, via the electronic processor, an operation of the bidirectional DC/DC converter to regulate the voltage of the DC bus within a predefined operating range based on a load condition.

Example 14. The method of example 11, wherein the electronic device further comprises a plurality of AC input interfaces, each having an input switch, and the method further comprises: selectively enabling or disabling, via the electronic processor, one or more of the input switches based on input current ratings to provide AC input power.

Example 15. The method of example 11, wherein the electronic device further comprises a solar boost converter electrically coupled to a solar interface and the DC bus, and the method further comprises: controlling, via the electronic processor, the solar boost converter to transfer power from the solar interface to the battery interface or DC bus; and selectively coupling the solar boost converter to one or more DC buses via switch control based on solar input availability.

Example 16. The method of example 11, wherein the AC output interface is one of a plurality of AC output interfaces included in the electronic device, and the method further comprises: controlling, via the electronic processor, power from the AC input interface and the battery interface to select ones of the plurality of AC output interfaces based on a current draw or a predefined load threshold.

Example 17. An electronic device comprising: an alternating current (AC) input interface; an AC output interface; a direct current (DC) bus; a battery interface; a power factor correction (PFC) circuit electrically connected between the AC input interface and the DC bus, the PFC circuit configured to convert AC power from the AC input interface to DC power at the DC bus and to regulate a voltage level of the DC bus; a bidirectional AC/DC active front end (AFE) drive circuit electrically connected between the DC bus and the AC output interface, the AFE drive circuit configured to convert DC power from the DC bus to provide AC power at the AC output interface, and to convert AC power from the AC output interface to DC power at the DC bus; a bidirectional DC/DC converter electrically connected between the DC bus and the battery interface, the bidirectional DC/DC converter configured to convert DC power from the battery interface to the DC bus, and convert DC power from the DC bus to charge a battery electrically connected to the battery interface; an output switch between the AFE drive circuit and the AC output interface; and an electronic processor configured to: determine a difference between a power level available at the AC input interface and a power demand at the AC output interface; in response to determining that the power demand at the AC output interface is greater than or equal to the power level available at the AC input interface, close the output switch and control the AFE drive circuit and the bidirectional DC/DC converter to supplement the AC output power using power from the battery interface; in response to determining that the power demand at the AC output interface is less than the power level available at the AC input interface open the output switch and control the PFC circuit and the bidirectional DC/DC converter to provide DC power from the AC input interface to the battery interface for charging the battery; and control the PFC circuit to regulate the DC bus voltage to maintain a predetermined power level.

Example 18. The electronic device of example 17, further comprising a solar boost converter electrically connected to the battery interface via a second DC bus, the solar boost converter configured to regulate voltage received from a solar interface and provide charging power to the battery interface.

Example 19. The electronic device of example 17, wherein the electronic processor is further configured to: control the output switch and the AFE drive circuit to enable a passthrough mode in which AC input power from the AC input interface is directly routed to the AC output interface when the power level at the AC input interface exceeds a predetermined threshold.

Example 20. The electronic device of example 17, wherein the AC input interface comprises a plurality of AC input terminals each rated for different current levels, and the electronic processor is configured to selectively enable one or more of the plurality of AC input terminals based on an available grid power.

Example 21. The electronic device of example 17, wherein the AC output interface comprises a plurality of output ports, wherein each of the plurality of output ports is controllable by the electronic processor, and the electronic processor is configured to provide power between the plurality of output ports based on a predefined rating or a user-defined parameter.

Example 22. A method of controlling an electronic device including an AC input interface, an AC output interface, a DC bus, a battery interface, a bidirectional AC/DC active front end (AFE) drive circuit, a bidirectional DC/DC converter, and an electronic processor, the method comprising: determining, via the electronic processor, a difference between a power level available from the AC input interface and a power demand at the AC output interface; and controlling, via the electronic processor, simultaneous delivery of power from the AC input interface and the battery interface based on the difference between the power level available from the AC input interface and the power demand at the AC output interface.

Although the disclosure has been described in detail with reference to certain preferred embodiments, variations and modifications exist within the scope and spirit of one or more independent aspects of the disclosure as described. Various features and advantages are set forth in the following claims.

What is claimed is:

1. An electronic device comprising:
an alternating current (AC) input interface;
an AC output interface;
a direct current (DC) bus;
a battery interface;
a bidirectional AC/DC active front end (AFE) drive circuit electrically connected between the AC input interface, the AC output interface, and the DC bus, wherein the bidirectional AC/DC AFE drive circuit is configured to convert AC power from the AC input interface to DC power at the DC bus and convert DC power from the DC bus to provide AC power at the AC output interface;
a bidirectional DC/DC converter electrically connected between the DC bus and the battery interface, the bidirectional DC/DC converter configured to convert DC power received from a battery electrically connected to the battery interface to DC power at the DC bus and convert DC power from the DC bus to charge the battery;
an output switch between the AFE drive circuit and the AC output interface; and
an electronic processor configured to:
determine a difference in a power level available at the AC input power and a power demand at the AC output interface; and
in response to the power demand at the AC output interface being greater than or equal to the power level available at the AC input power, close the output switch and control the AFE drive circuit and the bidirectional DC/DC converter to provide AC output power at the AC output interface.

2. The electronic device of claim 1, further comprising an input switch between the AC input interface and the AFE drive circuit, wherein the electronic processor is further configured to selectively open or close the input switch based on the power level available at the AC input interface.

3. The electronic device of claim 2, wherein the electronic processor is configured to selectively open or close the input switch by maintaining the input switch in a closed state when the power level available at the AC input interface is below the power demand at the AC output interface to enable a supplemental AC output power from both the AC input and the battery interface.

4. The electronic device of claim 1, further comprising a plurality of AC input interfaces, each of the plurality of AC input interfaces rated for a different maximum current level, and wherein the electronic processor is configured to select one of the plurality of the AC input interfaces based on an available input current.

5. The electronic device of claim 1, wherein the AC output interface is one of a plurality of AC output interfaces, each of the plurality of AC output interfaces configured to provide a different maximum output current, wherein the electronic processor is configured to direct output power to one of the plurality of AC output interfaces based on the power level available at the AC input interface and a battery charge state.

6. The electronic device of claim 1, further comprising a power factor correction (PFC) circuit electrically connected between the AC input interface and the DC bus, wherein the electronic processor is configured to control the PFC circuit to maintain a desired voltage level at the DC bus when converting power from the AC input interface.

7. The electronic device of claim 1, further comprising a solar boost converter coupled to the battery interface and configured to receive power from a solar interface, the solar boost converter configured to regulate photovoltaic voltage to meet a predefined voltage level for battery charging.

8. The electronic device of claim 1, wherein in response to the power demand at the AC output interface being less than the power level available at the AC input power, the electronic processor is further configured to open the output switch and control the AFE drive circuit and the bidirectional DC/DC converter to provide DC power output at the battery interface.

9. The electronic device of claim 1, wherein the electronic processor is further configured to monitor a state of charge of the battery and, in response to the battery reaching a threshold charge level, restrict discharge from the battery.

10. The electronic device of claim 1, wherein the DC bus is regulated to a voltage between 200 Volts and 400 Volts, and the electronic processor is further configured to maintain the regulation during transitions between operating modes, the operating modes including providing power from the battery interface and providing power to the battery interface.

11. A method of controlling an electronic device including an AC input interface, an AC output interface, a DC bus, a battery interface, a bidirectional AC/DC active front end (AFE) drive circuit, a bidirectional DC/DC converter, and an electronic processor, the method comprising:
determining, via the electronic processor, a difference between a power level available from the AC input interface and a power demand at the AC output interface; and
in response to determining that the power demand at the AC output interface is greater than or equal to the power level available at the AC input interface:
controlling, via the electronic processor, an output switch between the AFE drive circuit and the AC output interface to a closed state; and
controlling, via the electronic processor, the AFE drive circuit and the bidirectional DC/DC converter to provide supplemental AC output power at the AC output interface using stored energy from a battery electrically connected to the battery interface.

12. The method of claim 11, further comprising:
in response to determining that the power demand at the AC output interface is less than the power level available at the AC input interface:
controlling, via the electronic processor, the output switch to an open state; and
controlling the AFE drive circuit and the bidirectional DC/DC converter to provide DC power from the AC input interface to the battery interface to charge the battery.

13. The method of claim 11, further comprising:
monitoring, via the electronic processor, a voltage level of the DC bus; and
adjusting, via the electronic processor, an operation of the bidirectional DC/DC converter to regulate the voltage of the DC bus within a predefined operating range based on a load condition.

14. The method of claim 11, wherein the electronic device further comprises a plurality of AC input interfaces, each having an input switch, and the method further comprises:
selectively enabling or disabling, via the electronic processor, one or more of the input switches based on input current ratings to provide AC input power.

15. The method of claim 11, wherein the electronic device further comprises a solar boost converter electrically coupled to a solar interface and the DC bus, and the method further comprises:
controlling, via the electronic processor, the solar boost converter to transfer power from the solar interface to the battery interface or DC bus; and
selectively coupling the solar boost converter to one or more DC buses via switch control based on solar input availability.

16. The method of claim 11, wherein the AC output interface is one of a plurality of AC output interfaces included in the electronic device, and the method further comprises:
controlling, via the electronic processor, power from the AC input interface and the battery interface to select ones of the plurality of AC output interfaces based on a current draw or a predefined load threshold.

17. An electronic device comprising:
an alternating current (AC) input interface;
an AC output interface;
a direct current (DC) bus;
a battery interface;
a power factor correction (PFC) circuit electrically connected between the AC input interface and the DC bus, the PFC circuit configured to convert AC power from the AC input interface to DC power at the DC bus and to regulate a voltage level of the DC bus;
a bidirectional AC/DC active front end (AFE) drive circuit electrically connected between the DC bus and the AC output interface, the AFE drive circuit configured to convert DC power from the DC bus to provide AC power at the AC output interface, and to convert AC power from the AC output interface to DC power at the DC bus;
a bidirectional DC/DC converter electrically connected between the DC bus and the battery interface, the bidirectional DC/DC converter configured to convert DC power from the battery interface to the DC bus, and convert DC power from the DC bus to charge a battery electrically connected to the battery interface;
an output switch between the AFE drive circuit and the AC output interface; and
an electronic processor configured to:
determine a difference between a power level available at the AC input interface and a power demand at the AC output interface;
in response to determining that the power demand at the AC output interface is greater than or equal to the power level available at the AC input interface, close the output switch and control the AFE drive circuit and the bidirectional DC/DC converter to supplement the AC output power using power from the battery interface;
in response to determining that the power demand at the AC output interface is less than the power level available at the AC input interface open the output switch and control the PFC circuit and the bidirectional DC/DC converter to provide DC power from the AC input interface to the battery interface for charging the battery; and
control the PFC circuit to regulate the DC bus voltage to maintain a predetermined power level.

18. The electronic device of claim 17, further comprising a solar boost converter electrically connected to the battery interface via a second DC bus, the solar boost converter configured to regulate voltage received from a solar interface and provide charging power to the battery interface.

19. The electronic device of claim 17, wherein the electronic processor is further configured to:
control the output switch and the AFE drive circuit to enable a passthrough mode in which AC input power from the AC input interface is directly routed to the AC output interface when the power level at the AC input interface exceeds a predetermined threshold.

20. The electronic device of claim 17, wherein the AC input interface comprises a plurality of AC input terminals each rated for different current levels, and the electronic processor is configured to selectively enable one or more of the plurality of AC input terminals based on an available grid power.

21. The electronic device of claim 17, wherein the AC output interface comprises a plurality of output ports, wherein each of the plurality of output ports is controllable by the electronic processor, and the electronic processor is configured to provide power between the plurality of output ports based on a predefined rating or a user-defined parameter.

22. A method of controlling an electronic device including an AC input interface, an AC output interface, a DC bus, a battery interface, a bidirectional AC/DC active front end (AFE) drive circuit, a bidirectional DC/DC converter, and an electronic processor, the method comprising:
determining, via the electronic processor, a difference between a power level available from the AC input interface and a power demand at the AC output interface; and
controlling, via the electronic processor, simultaneous delivery of power from the AC input interface and the battery interface based on the difference between the power level available from the AC input interface and the power demand at the AC output interface.
